(19) United States
(12) Patent Application Publication
(10) Pub. No.: US 2024/0392703 A1
(43) Pub. Date: Nov. 28, 2024

(54) ENGINE VALVE CONFIGURATION

(71) Applicant: Ralf Centmayer, Markdorf (DE)

(72) Inventor: Ralf Centmayer, Markdorf (DE)

(21) Appl. No.: 18/671,970

(22) Filed: May 22, 2024

Related U.S. Application Data
(63) Continuation-in-part of application No. 18/670,693, filed on May 21, 2024.
(63) Continuation-in-part of application No. 18/651,652, filed on Apr. 30, 2024.
(63) Continuation-in-part of application No. 18/650,021, filed on Apr. 29, 2024.
(63) Continuation-in-part of application No. 18/649,993, filed on Apr. 29, 2024.
(60) Provisional application No. 63/545,106, filed on Oct. 20, 2023.
(60) Provisional application No. 63/544,072, filed on Oct. 13, 2023.
(60) Provisional application No. 63/542,865, filed on Oct. 6, 2023.
(60) Provisional application No. 63/468,357, filed on May 23, 2023.

(51) Int. Cl. F01L 1/04; F01L 1/24; F02F 1/42

(52) U.S. Cl. CPC F01L 1/04; F01L 1/2405; F02F 1/4285; F01L 2250/02

(57) ABSTRACT

The present disclosure relates to an engine assembly for a vehicle. The engine assembly comprises an engine that includes a cylinder head housing a valve train assembly and a valve cover covering a top of the cylinder head. The engine may be used in different models of the vehicle having different characteristics by configuring the valve train assembly to position camshafts such that either the intake or exhaust ports may be positioned to front or rear side of the cylinder head, while keeping one or more other engine components, such as camshaft positioning, camshaft drive and/or the valve cover the same. In the valve train assembly, finger followers are arranged on the same side of each camshaft and the hydraulic compensators are arranged opposite side of the finger followers. The engine of the present disclosure may also enable alignment and ease of installation and removal of the valve cover.

### PRIORITY CLAIM

This application is a continuation-in-part of U.S. patent application Ser. No. 18/670,693, filed May 21, 2024; and is a continuation-in-part of U.S. patent application Ser. No. 18/651,652 filed Apr. 30, 2024; and is a continuation-in-part of U.S. patent application Ser. No. 18/650,021 filed Apr. 29, 2024; and is a continuation-in-part of U.S. patent application Ser. No. 18/649,993 filed Apr. 29, 2024; and claims the benefit of priority from U.S. Provisional Patent Application Nos. 63/545,106 filed Oct. 20, 2023; 63/544,072 filed Oct. 13, 2023; 63/542,865 filed Oct. 6, 2023; and 63/468,357 filed May 23, 2023, the contents of which are incorporated herein by reference in their entirety.

### FIELD OF THE DISCLOSURE

The present disclosure generally relates to engines for off-road vehicles. More particularly, the present disclosure relates to a cylinder head housing a valve train assembly of an engine assembly.

### BACKGROUND

An internal combustion engine of a vehicle converts heat energy into mechanical energy to propel moving parts of the vehicle, thereby facilitating movement of the vehicle. Engines typically feature a cylinder head and an engine block. The cylinder head houses a valve train and other associated components, which regulate intake and exhaust processes. Meanwhile, the engine block houses cylinders where combustion occurs and a crankshaft that converts combustion or heat energy into mechanical energy to propel the vehicle. Engine designs and structures vary based on vehicle types to meet specific needs and parameters. For example, off-road vehicles like all-terrain vehicles (ATVs) and side-by-side utility terrain vehicles (UTVs or side-by-side) may differ in engine design from snowmobiles. Additionally, within each category, vehicles may serve different purposes, such as utility or sport. Depending on the application, a cylinder head with forward intake or a rearward intake configuration, corresponding valve train configuration and other configurations are chosen.

Conventional engines currently available are designed for specific applications and specific operating conditions, which are generally neither adaptable nor upgradable for other applications and other operating conditions. Thus, a number of engine components to be replaced or modified are increased while adapting to different vehicles. In some cases, entire engine replacement is required according to a specific application. For example, existing valve train arrangements do not allow exchange or reconfiguration of valve train components to orient or position intake or exhaust ports towards front or rear side of the vehicle. In addition, or alternatively, engines for different applications typically require different valve covers, camshaft drive configurations, etc. to be used according to intake and exhaust port configuration in the existing engines. In addition, or alternatively, existing cylinder heads do not allow for case of installation and removal of the valve covers.

### SUMMARY

In some embodiments, an engine is provided that is adaptable to different vehicles without changing a basic design of the engine. The engine is made to allow interchangeability of one or more valve train components while other engine components remain constant and may further allow for case of installation and removal of valve covers.

In some embodiments, the present disclosure sets forth an engine assembly of a vehicle extending from a front end to a rear end in a longitudinal direction. The engine assembly includes an engine including a cylinder head comprising a valve train assembly. The valve train assembly includes a first camshaft and a second camshaft. The valve train assembly is configured to position the first camshaft and the second camshaft such that the cylinder head from a first cylinder head or a second cylinder head having a different configuration than the first cylinder head is selected. A first camshaft position and a second camshaft position are the same for the first cylinder head and the second cylinder head. The first camshaft may be selected from a forward intake camshaft or a forward exhaust camshaft. The second camshaft may be selected from a rearward intake camshaft or a rearward exhaust camshaft.

In some embodiments, the valve train assembly is configured to position the first camshaft and the second camshaft at a first camshaft mounting location and a second camshaft mounting location, respectively, in the cylinder head. The first camshaft mounting location is the same for the forward intake camshaft and the forward exhaust camshaft. The second camshaft mounting location is the same for the rearward intake camshaft and the rearward exhaust camshaft.

The valve train assembly may be configured to have equal spacing between the first camshaft and the second camshaft on the first camshaft mounting location and the second camshaft mounting location, respectively, in the first cylinder head and the second cylinder head. Relative positioning of the first camshaft and the second camshaft with respect to cylinders or a drive chain assembly are the same for the first cylinder head and the second cylinder head.

In some embodiments, the valve train assembly further comprises a plurality of finger followers and a plurality of hydraulic compensators. Relative positioning of the finger followers and hydraulic compensators with respect to the cylinders or the drive chain assembly in the valve train assembly are the same for the first cylinder head and the second cylinder head. The finger followers are arranged at the same side of each of the first camshaft and the second camshaft (i.e., both on the forward side or both on the rearward side). The hydraulic compensators are arranged at an opposite side of the finger followers.

In some embodiments, the valve train assembly further comprises a plurality of intake valves and a plurality of exhaust valves. Relative positioning of the intake valves and the exhaust valves with respect to the cylinders or the drive chain assembly in the valve train assembly are the same for the first cylinder head and the second cylinder head.

The hydraulic compensators and corresponding valve stems of each of the plurality of intake valves and the plurality of exhaust valves may be non-parallel to each other.

In some embodiments, exhaust channels of the first cylinder head are configured to have a first curved portion to accommodate corresponding valve springs of each of the plurality of exhaust valves.

In some embodiments, inlet channels of the second cylinder head are configured to have a second curved portion to accommodate corresponding valve springs of each of the plurality of intake valves. The first curved portion and the second curved portion are different.

In some embodiments, the hydraulic compensators are away from the inlet and exhaust channels of the cylinder head.

In some embodiments, the engine further comprises a valve cover that is configured to be mounted on top of the cylinder head for housing the valve train assembly. The valve cover is the same for the first cylinder head and the second cylinder head. The valve cover comprises at least one second opening for inserting at least spark plug therethrough into at least one first opening of the cylinder head, thereby lower end of the at least one spark plug exposed within a top of each cylinder. The first opening aligns with the second opening. The valve cover further comprises a first seal for providing sealing between the at least one first opening of the cylinder head and the at least one second opening of the valve cover.

In some embodiments, the cylinder head comprises a recess surrounding a perimeter of the at least one first opening of the cylinder head. The first seal is configured to be positioned in the recess of the cylinder head. An underside of the valve cover may comprise a flat surface surrounding a bottom of the at least one second opening for interfacing with a flat top surface of the first seal of the valve cover.

### BRIEF DESCRIPTION OF THE DRAWINGS

A more complete understanding of the present disclosure may be derived by referring to the detailed description and claims when considered in connection with the Figures, wherein like reference numerals refer to similar elements throughout the Figures

FIG. 1A illustrates an exemplary perspective view of an off-road vehicle.

FIG. 1B illustrates an exemplary above view of an engine with forward intake ports, mounted in a rear portion of a vehicle in accordance with the present disclosure.

FIG. 2A illustrates an exemplary side view of an off-road vehicle.

FIG. 2B illustrates an exemplary above view of an engine with forward exhaust ports, mounted in a front portion of a snowmobile in accordance with the present disclosure.

FIG. 3 illustrates an exemplary isometric view of an engine with forward intake ports in accordance with the present disclosure.

FIGS. 4A and 4B illustrate exemplary isometric views of an engine with forward exhaust ports in accordance with the present disclosure.

FIGS. 5 and 6 illustrate exemplary isometric views of an engine where portions of a cylinder head and a valve cover are removed, showing a valve train assembly in accordance with the present disclosure.

FIGS. 7 and 8 illustrate exemplary isometric views of an engine with forward intake ports where outer portions are removed, showing a valve train assembly and inlet and exhaust channels of a cylinder head in accordance with the present disclosure.

FIG. 9 illustrates an exemplary side-elevational view, from a right side of a vehicle, of an engine with forward intake ports where outer portions are removed, showing a valve train assembly and inlet and exhaust channels of a cylinder head in accordance with the present disclosure.

FIGS. 10 and 11 illustrate exemplary cross-sectional views of an engine with forward intake ports in accordance with the present disclosure.

FIG. 12 illustrates an exemplary plan view of an engine with forward intake ports in accordance with the present disclosure.

FIGS. 13 and 14A illustrate exemplary isometric views of an engine with forward exhaust ports where outer portions are removed, showing a valve train assembly and inlet and exhaust channels of a cylinder head in accordance with the present disclosure.

FIG. 14B illustrates an exemplary isometric view of an engine, where outer portions are removed, showing a valve train assembly, a drive chain assembly, an oil pump, and a coolant pump in accordance with the present disclosure.

FIG. 15 illustrates an exemplary side-elevational view, from a right side of a vehicle, of an engine with forward exhaust ports where outer portions are removed, showing a valve train assembly and inlet and exhaust channels of a cylinder head in accordance with the present disclosure.

FIGS. 16 and 17 illustrate exemplary cross-sectional views of an engine with forward exhaust ports in accordance with the present disclosure.

FIG. 18 illustrates an exemplary plan view of an engine with forward exhaust ports in accordance with the present disclosure.

FIG. 19 illustrates an exemplary isometric view of an engine with forward exhaust ports, where valve cover is removed, showing a cylinder head without seals in accordance with the present disclosure.

FIG. 20 illustrates an exemplary isometric view of a cylinder head without seals in accordance with the present disclosure.

FIG. 21 illustrates an exemplary isometric view of an engine with forward exhaust ports, where valve cover is removed, showing a cylinder head with seals in accordance with the present disclosure.

FIG. 22 illustrates an exemplary isometric view of a valve cover in accordance with the present disclosure.

FIG. 23 illustrates an exemplary isometric view of a valve cover covering a top of a cylinder head in accordance with the present disclosure.

FIG. 24 illustrates an exemplary cross-sectional view of an engine showing a first seal in a recess of a cylinder head in accordance with the present disclosure.

### DETAILED DESCRIPTION

The following description sets forth exemplary embodiments of the invention only, and is not intended to limit the scope, applicability, or configuration of the invention. Rather, the following description is intended to provide a convenient illustration for implementing various embodiments of the invention. As will become apparent, various changes may be made in the function and arrangement of the elements described in these embodiments without departing from the scope of the invention as set forth herein. It should be appreciated that the description herein may be adapted to be employed with alternatively configured devices having different shapes, components, attachment mechanisms, and the like and still fall within the scope of the present invention. Thus, the detailed description herein is presented for purposes of illustration only and not of limitation.

Reference in the specification to “one embodiment” or “an embodiment” is intended to indicate that a particular feature, structure, or characteristic described in connection with the embodiment is included in at least an embodiment of the invention. The appearances of the phrase “in one embodiment” or “an embodiment” in various places in the specification are not necessarily all referring to the same embodiment.

Embodiments of the present disclosure describe an engine assembly and a vehicle having the engine assembly. The term ‘engine assembly’ used throughout the disclosure may comprise an engine and associated parts. The engine may be an internal combustion (IC) engine (ICE). The engine comprises a cylinder head housing a valve train assembly, an engine block housing cylinders and a crankshaft, a valve cover covering or protecting a top of the cylinder head, a drive chain assembly, and other associated parts known to a person skilled in the art.

The valve train assembly comprises camshafts, valves and associated parts, finger followers, hydraulic compensators, and other associated parts. Components described herein may be utilized for different vehicles such as on-road vehicles and off-road vehicles. For example, the engine of the present disclosure may be used in different models of the vehicle having different characteristics by configuring the valve train assembly to position the camshafts such that either the intake or exhaust ports may be positioned to front or rear side of the cylinder head, while keeping one or more other engine components, such as camshaft positioning, camshaft drive and/or the valve cover the same. Accordingly, the number of engine components to be replaced or modified are reduced (i.e., maximizing common components) while adapting to different vehicles and different models of the vehicles. In other words, the engine of the present disclosure may be used in different models of the vehicle having different characteristics due to a same cam shaft location on both intake and exhaust sides of a cylinder head with forward intake configuration and rearward intake configuration. Such that, the engine of the present disclosure may offer interchangeability of cylinder heads between forward intake configuration and rearward intake configuration due to the same cam shaft mounting on both intake and exhaust sides of the cylinder head.

The engine of the present disclosure may facilitate alignment and case of installation and removal of the valve cover, thereby improving installation efficiency of the valve cover and spark plugs. The engine of the present disclosure may offer optimum packaging of one or more components of the cylinder head in such a way by preventing interference of the one or more components of the cylinder head. Accordingly, performance of the engine is optimized. In an illustrative example, optimum packaging implies that the one or more components are arranged in a space-efficient manner within the cylinder head. In an illustrative example, the engine is a 4-stroke engine with three cylinders.

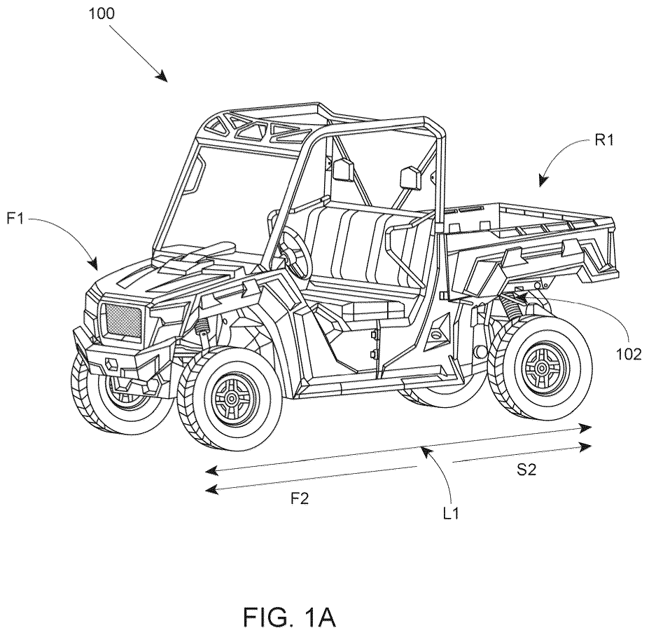

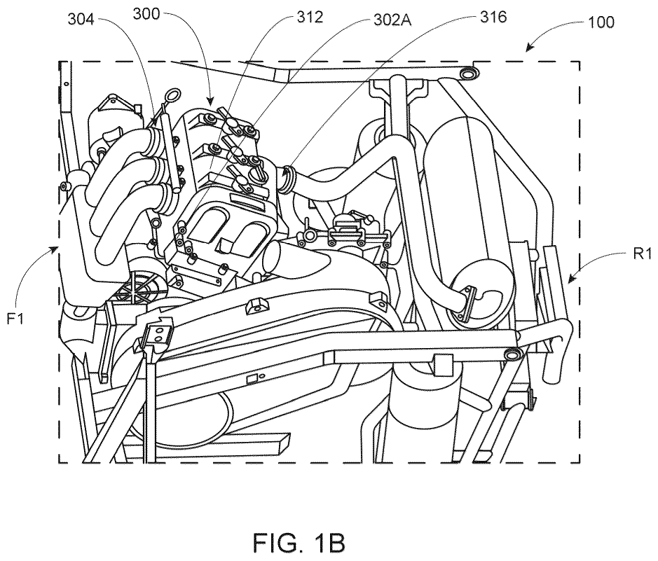

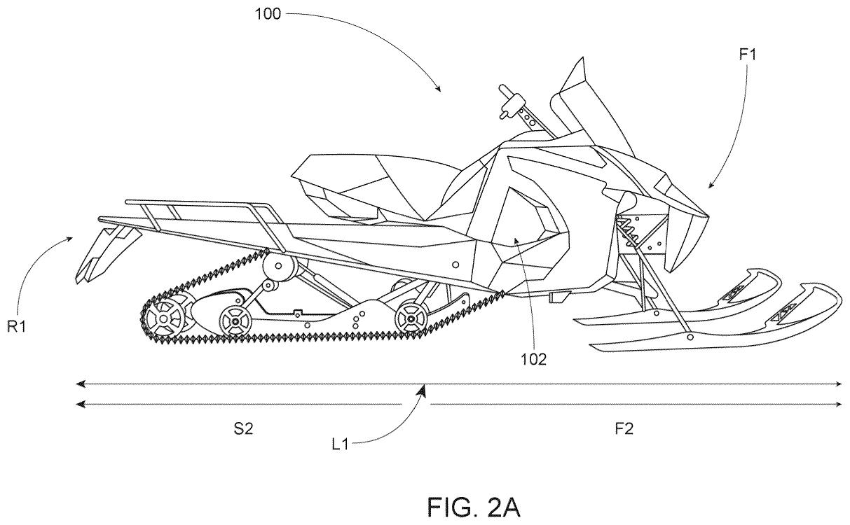

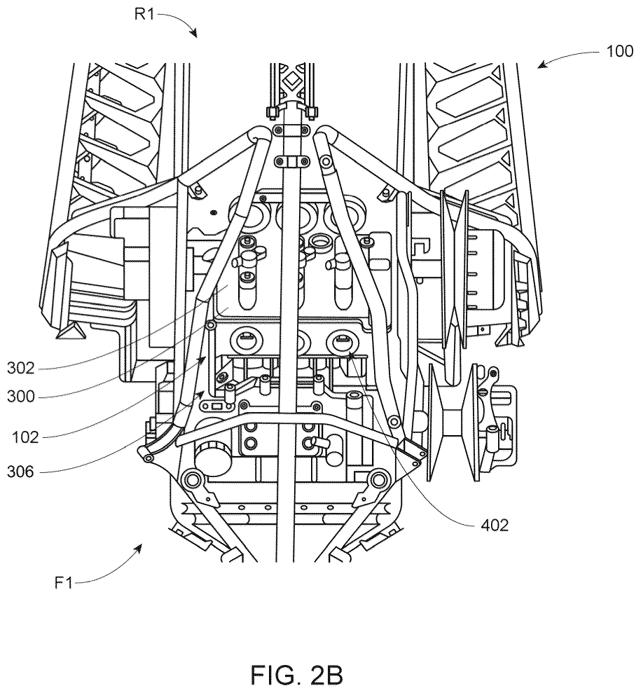

Reference is now made to FIGS. 1A-2A, which illustrate off-road vehicles such as a side-by-side vehicle and a snowmobile, respectively. It is to be noted that the present disclosure relates to engine assemblies of an off-road vehicle, represented as 100. Accordingly, the reference numeral 100 generally represents an off-road vehicle. Nonetheless, the engine assemblies of the present disclosure may be used in on road vehicles. The vehicle 100 extends from a front end (F1) to a rear end (R1) in a longitudinal direction having a longitudinal axis (L1).

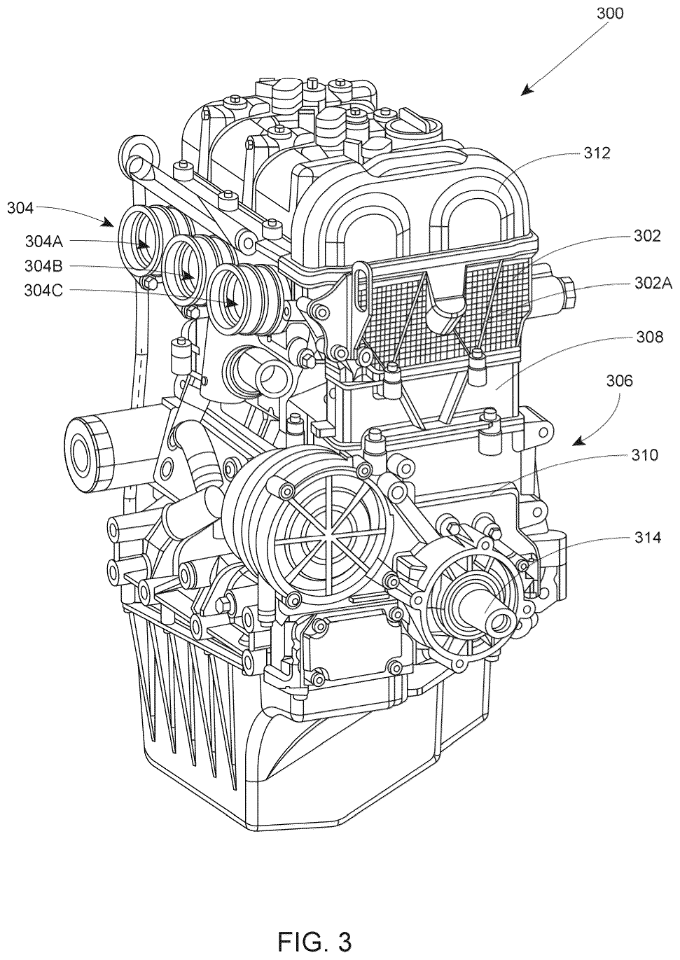

The vehicle 100 generally comprises an engine assembly 102 (pointing in a general location of an engine that is behind body panels shown) and other components that facilitate translation of combustion energy or thermal energy to rotational or mechanical energy for enabling movement of the vehicle 100. The engine assembly 102 comprises an engine 300. The engine 300 includes a cylinder head 302 and an engine block 306. The engine block 306 comprises a cylinder block 308 with cylinders 722 where combustion occurs and a crankcase 310 having a crankshaft 314 that converts the combustion or heat energy into the rotational energy to propel the vehicle 100 (seen e.g., in FIGS. 3, 4A, 4B, 10, and 16). The cylinder head 302 is mounted on top of the cylinder block 308 to form the tops of combustion chambers, which are formed by the cylinders 722. The cylinder head 302 may be removably attached to the cylinder block 308. A top of the cylinder head 302 is protected by a valve cover 312.

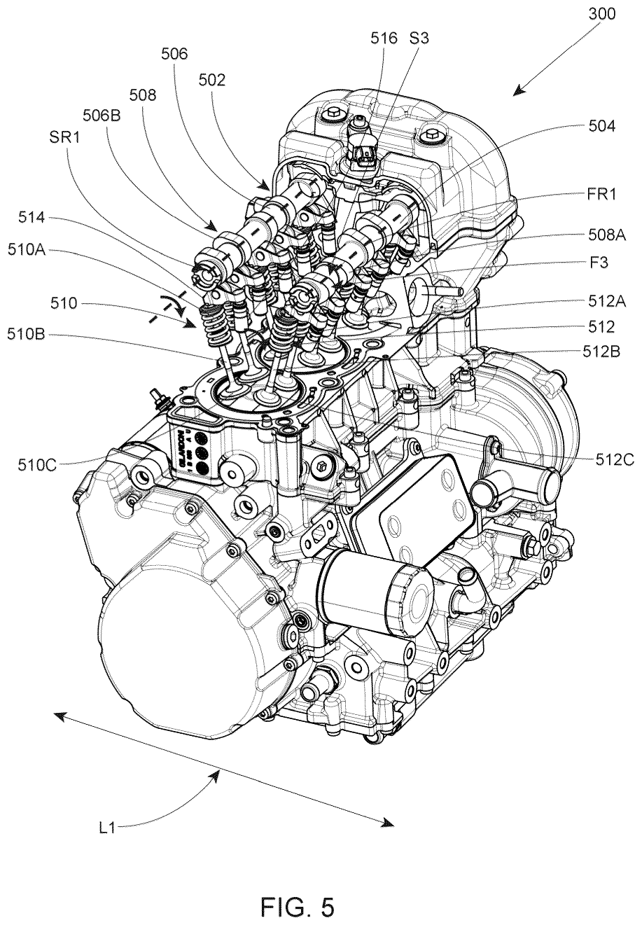

The cylinder head 302 is configured to house a valve train assembly 502 and associated components (see FIG. 5, for example). The valve train assembly 502 is configured for controlling the flow of gases into and out of the cylinders 722. In particular, the valve train assembly 502 is configured for controlling flow of an air-fuel mixture into the cylinders 722 for combustion process and gases produced by combustion of the air and fuel mixture out of the cylinders 722.

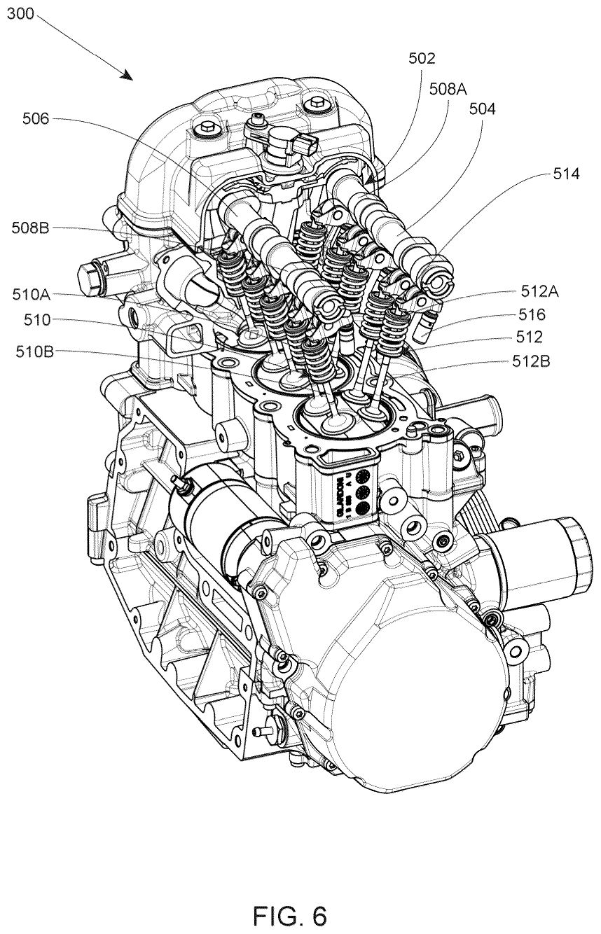

The valve train assembly 502 comprises a first camshaft 504, a second camshaft 506, a plurality of cam lobes 508 comprising a plurality of first cam lobes 508A and a plurality of second cam lobes 508B, a plurality of intake valves 510, a plurality of exhaust valves 512, a plurality of intake springs 510A, a plurality of exhaust springs 512A, a plurality of finger followers 514, a plurality of hydraulic compensators 516, and other associated components (seen e.g., in FIGS. 5 and 6). Each of the plurality of intake valves 510 comprises an intake valve stem 510B and an intake valve head 510C. A valve spring 510A encloses at least one portion of the intake valve stem 510B of each of the intake valves 510. Each of the plurality of exhaust valves 512 comprises an exhaust valve stem 512B and an exhaust valve head 512C. A valve spring 512A encloses at least one portion of the exhaust valve stem 512B of each of the exhaust valves 512.

The first camshaft 504 and the second camshaft 506 are rotatably mounted in the cylinder head 302 for operating the plurality of intake valves 510 and the plurality of exhaust valves 512 via the plurality of cam lobes 508 to regulate gases in and out of the cylinders 722. The finger followers 514 transmit the motion of the camshaft lobes 508 to the intake valves 510 and the exhaust valves 512 for opening and closing of the intake valves 510 and the exhaust valves 512 at precise intervals. The camshaft lobes 508 dictate valve lift and duration, determining the engine's intake and exhaust timing for optimal performance. The hydraulic compensators 516 maintain proper valve lash adjustment by automatically adjusting for wear and thermal expansion, ensuring consistent valve operation, and minimizing noise.

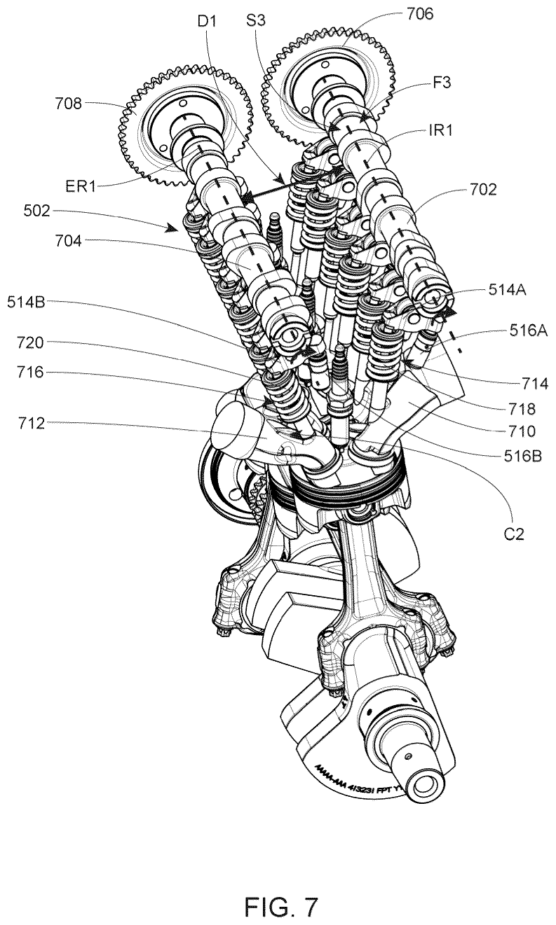

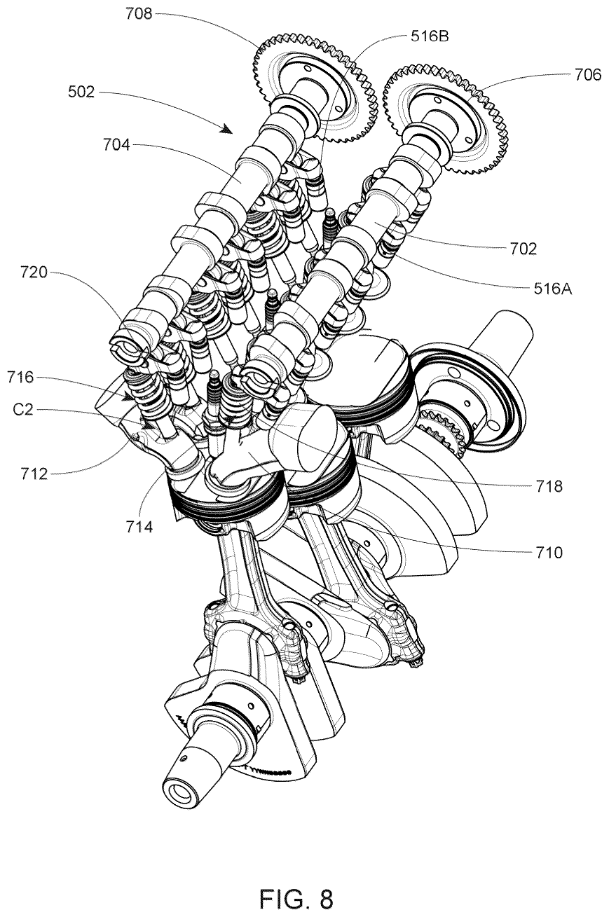

The valve train assembly 502 is configured to position the first camshaft 504 and the second camshaft 506 in the cylinder head 302 to allow the intake ports or exhaust ports to be positioned on either a front side or a rear side of the cylinder head 302. The front side of the cylinder head 302 corresponds to or otherwise faces the front end (F1) of the vehicle 100 and the rear side of the cylinder head 302 corresponds to or otherwise faces the rear end (R1) of the vehicle 100. In some embodiments, the first camshaft 504 is selected from a forward intake camshaft 702 or a forward exhaust camshaft 802. The second camshaft 506 is selected from a rearward intake camshaft 804 or a rearward exhaust camshaft 704 (seen e.g., in FIGS. 7, 8, 13, and 14A). In other words, the valve train assembly 502 allows for an exchange of the first camshaft 504 and the second camshaft 506 to configure the cylinder head 302 with front or rear intake ports. Accordingly, the valve train assembly 502 of the present disclosure enables to use a cylinder head with forward intake ports positioned on the front side of the cylinder head, or a cylinder head with rearward intake ports positioned on the rear side of the cylinder head. In an illustrative example, a cylinder head with forward intake ports positioned on the front side of the cylinder head is included on the side-by-side vehicle of FIGS. 1A and 1B, and a cylinder head with rearward intake ports positioned on the rear side of the cylinder head is included in the snowmobile vehicle of FIGS. 2A and 2B.

In preferred embodiments, the valves and the compensators do not change from one side of the engine to the other relative to the crankcase and cam drive assembly between the configurations of the forward intake and the forward exhaust. In other words, preferably the valves are positioned rearward of the compensators in both configurations-forward intake and rearward intake configurations.

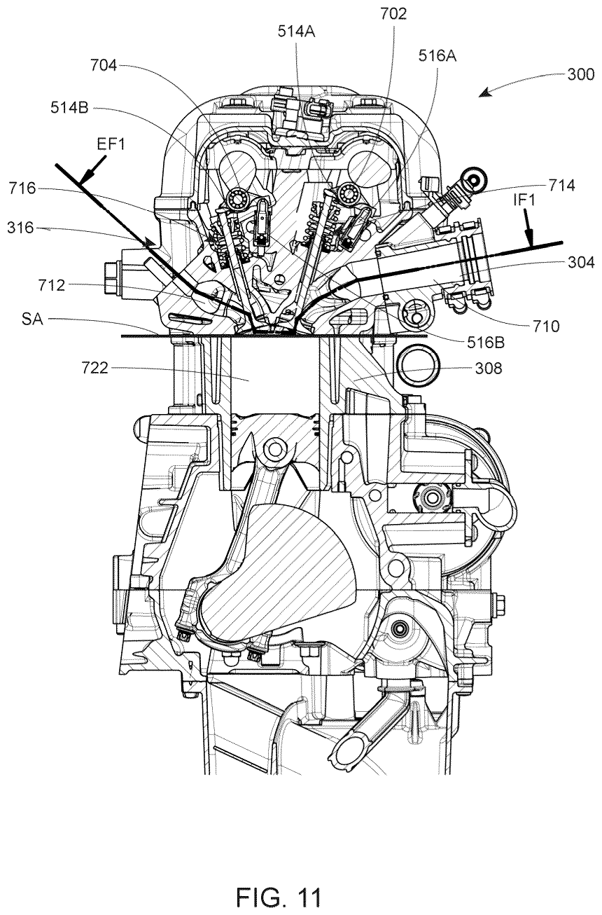

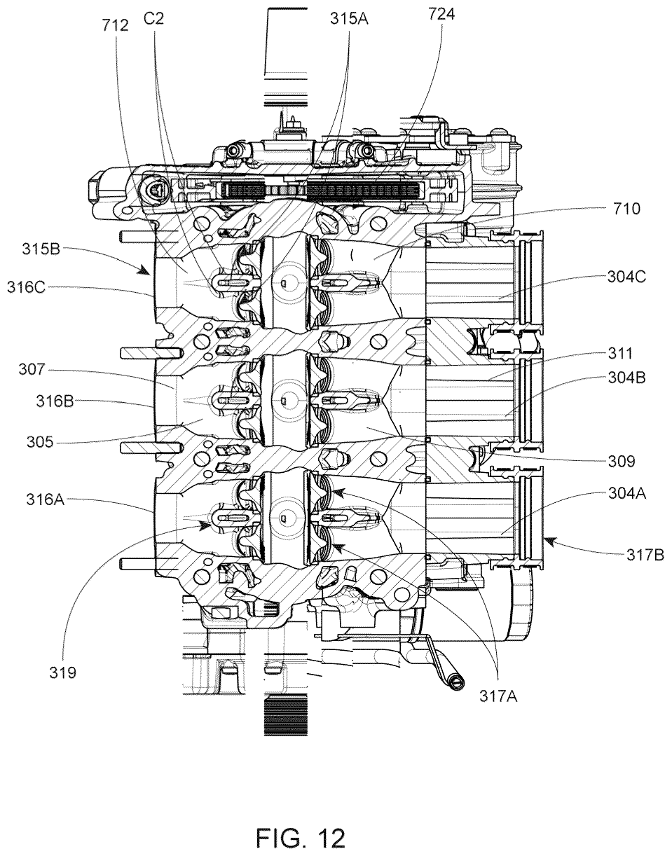

In some embodiments, the cylinder head 302 may be selected from a first cylinder head 302A or a second cylinder head 302B. In an illustrative example, the first cylinder head 302A is included on the UTV shown in FIG. 1A. The first cylinder head 302A comprises at least one forward intake port 304 through which the air and fuel mixture enters the cylinders 722 and at least one rearward exhaust port 316 through which gases produced by combustion of the air and fuel mixture are expelled out of the cylinders 722 (seen e.g., in FIGS. 3, 10, 11, and 12). The at least one forward intake port 304 of the first cylinder head 302A is configured to be positioned towards a first direction (F2) of the longitudinal axis (L1) of the vehicle 100. The at least one rearward exhaust port 316 is configured to be positioned towards a second direction (S2) of the longitudinal axis (L1) (seen e.g., in FIGS. 3 and 11). The first direction (F2) corresponds to the front end (F1) of the vehicle 100 and the second direction (S2) corresponds to the rear end (R1) of the vehicle 100. In some embodiments, the at least one forward intake port 304 comprises a first forward intake port 304A, a second forward intake port 304B, and a third forward intake port 304C (seen e.g., in FIGS. 3 and 12). In some embodiments, the at least one rearward exhaust port 316 comprises a first rearward exhaust port 316A, a second rearward exhaust port 316B, and a third rearward exhaust port 316C (seen e.g., in FIG. 12).

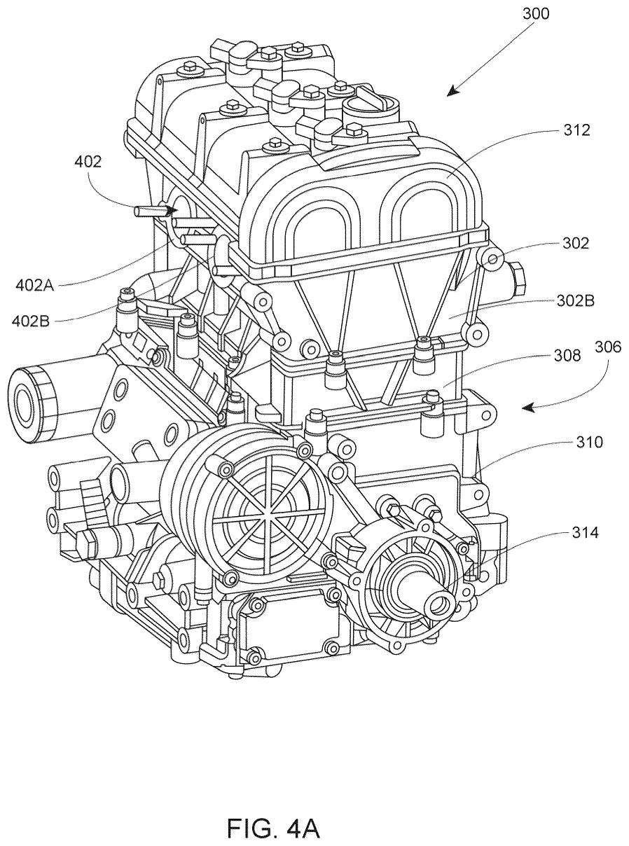

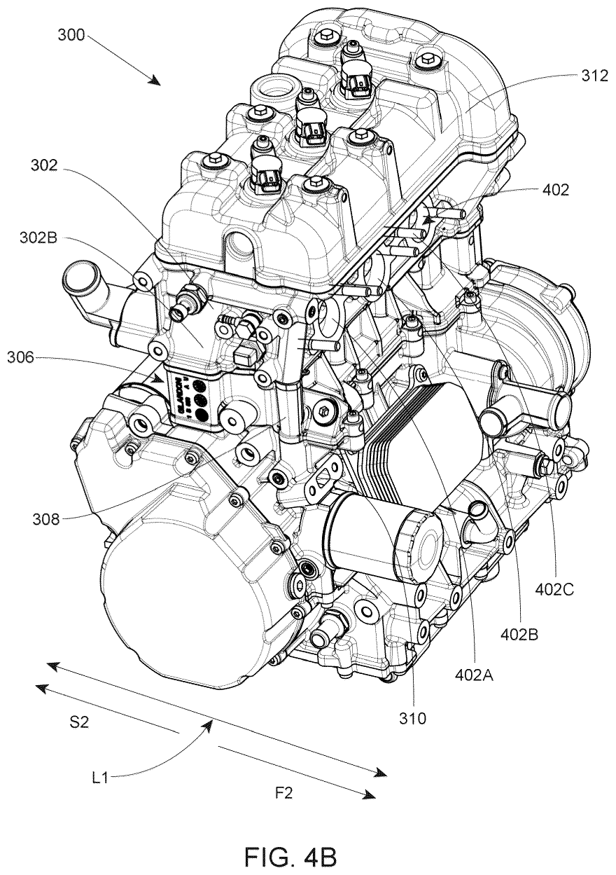

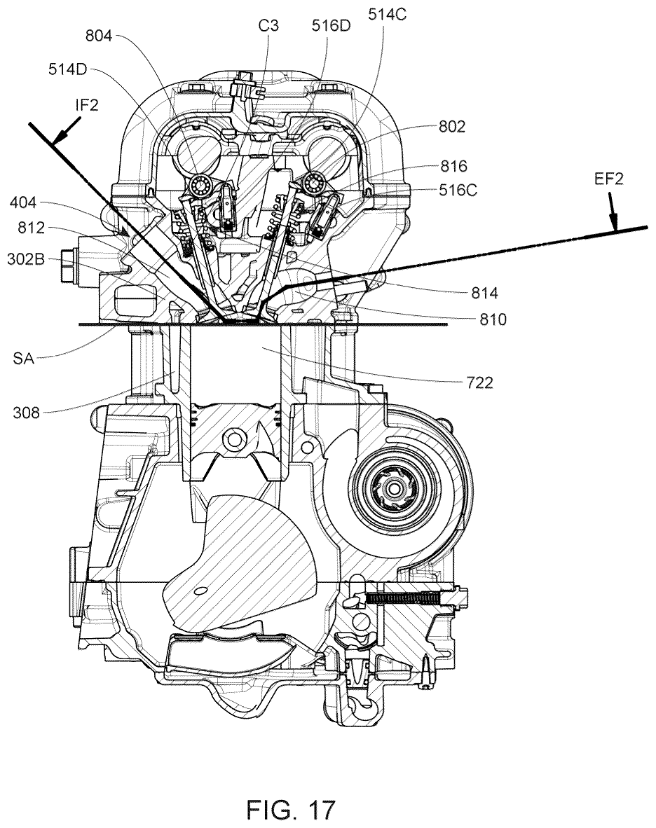

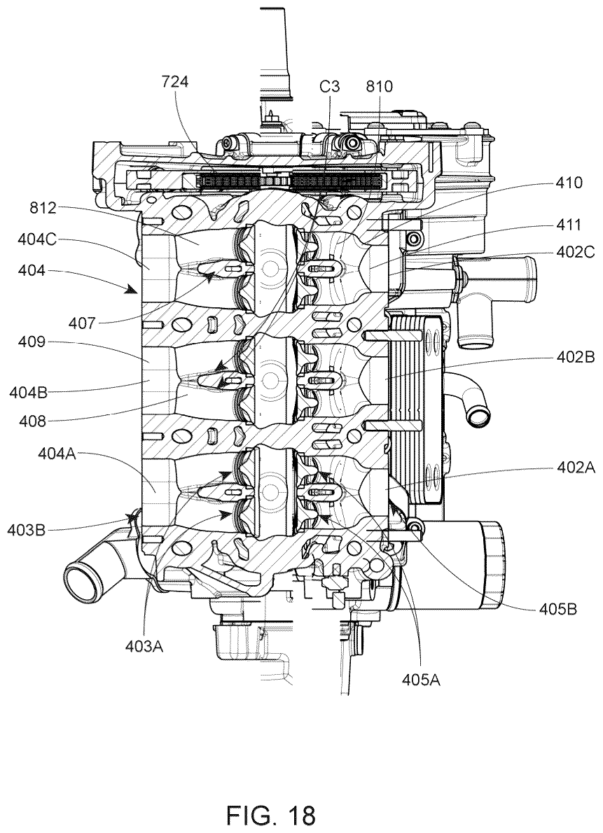

The second cylinder head 302B comprises at least one rearward intake port 404 through which the air and fuel mixture enters the cylinders 722 and at least one forward exhaust port 402 through which the gases produced by combustion of the air and fuel mixture are expelled out of the cylinders 722 (seen e.g., in FIGS. 4A, 4B, 16, and 18). In an illustrative example, the second cylinder head 302B is included on the snowmobile vehicle shown in FIGS. 2A and 2B. The at least one rearward intake port 404 is configured to be positioned towards the second direction (S2) of the longitudinal axis (L1) of the vehicle 100. The at least one forward exhaust port 402 is configured to be positioned towards the first direction (F2) of the longitudinal axis (L1) (seen e.g., in FIGS. 4A, 4B and 17). In some embodiments, the at least one rearward intake port 404 comprises a first rearward intake port 404A, a second rearward intake port 404B, and a third rearward intake port 404C (seen e.g., in FIG. 18). In some embodiments, the least one forward exhaust port 402 comprises a first forward exhaust port 402A, a second forward exhaust port 402B, and a third forward exhaust port 402C (seen e.g., in FIGS. 4A, 4B and 18).

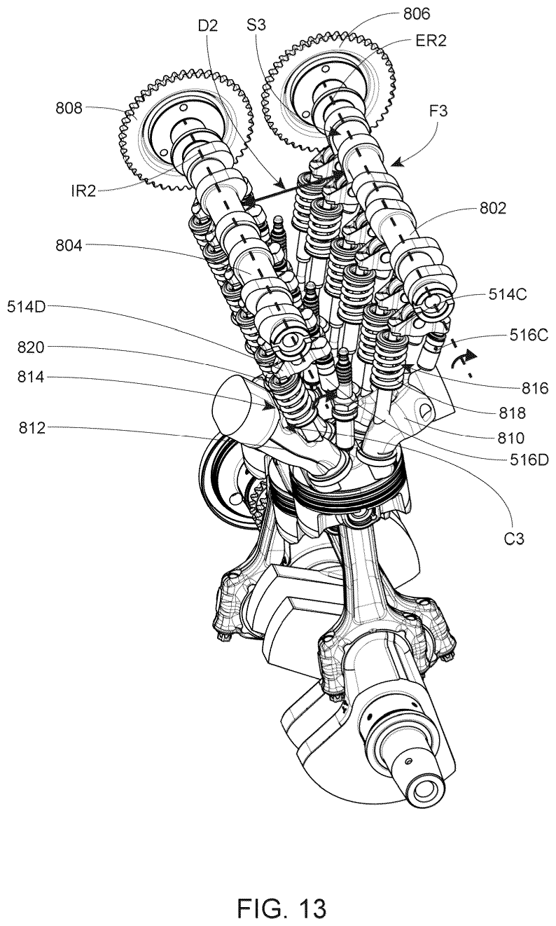

The forward intake camshaft 702 and the rearward exhaust camshaft 704 are configured to be positioned in the first cylinder head 302A. The forward intake camshaft 702 and the rearward exhaust camshaft 704 are driven by a first intake sprocket 706 and a first exhaust sprocket 708, respectively, that are attached to a first end of the forward intake camshaft 702 and the rearward exhaust camshaft 704 (seen e.g., in FIG. 7). The forward exhaust camshaft 802 and the rearward intake camshaft 804 are configured to be positioned in the second cylinder head 302B. The forward exhaust camshaft 802 and the rearward intake camshaft 804 are driven by a second exhaust sprocket 806 and a second intake sprocket 808, respectively, that are attached to a first end of the forward exhaust camshaft 802 and the rearward intake camshaft 804 (seen e.g., in FIG. 13). In some embodiments, the valve train assembly 502 of the present disclosure enables interchangeability between the first cylinder head 302A and the second cylinder head 302B according to a model and characteristics of the vehicle 100. Thus, commonality of parts is increased between (1) engines having a forward intake and rearward exhaust and (2) engines having a forward exhaust and rearward intake. Examples of engine components that do not necessarily have to be changed with a change of cylinder head include valve cover 312, cam drive assembly (guides, chain, sprockets), cylinders 722, cylinder block 308, crankshaft 314, crankcase 310, oil pump 762, and coolant pump 760.

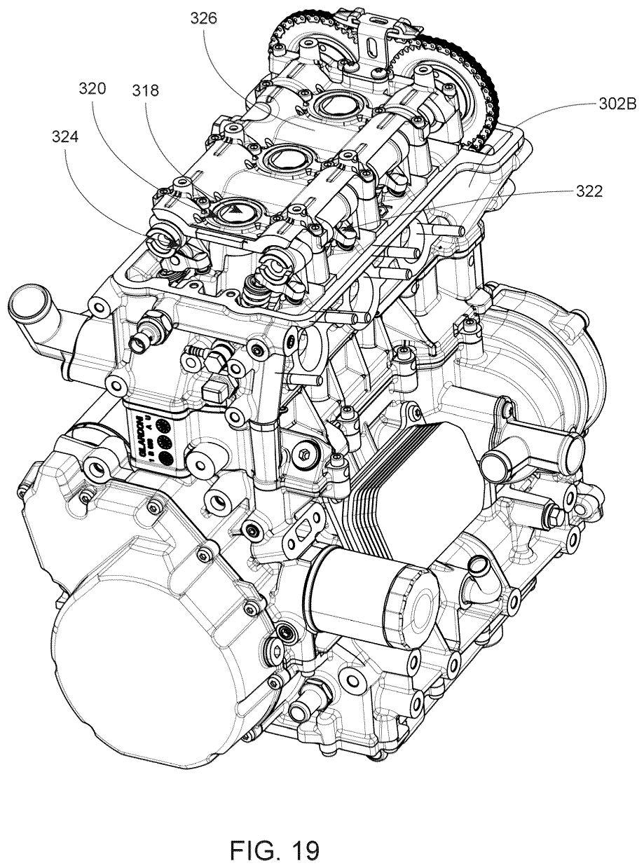

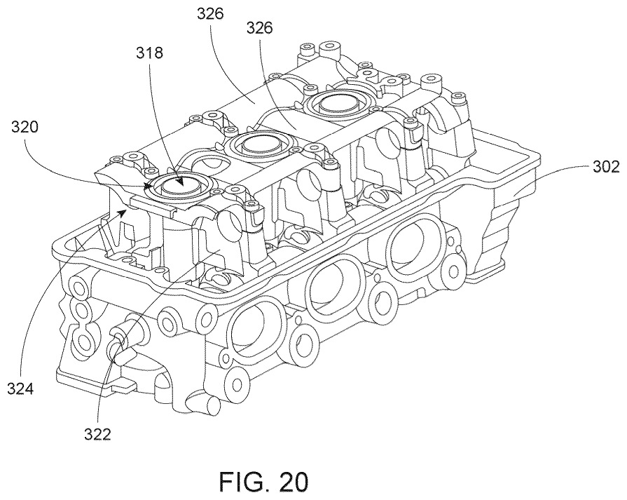

In some embodiments, the valve train assembly 502 is configured to position the first camshaft 504 and the second camshaft 506 at a first camshaft mounting location 322 and a second camshaft mounting location 324, respectively, in the cylinder head 302 (seen e.g., in FIGS. 19 and 20). The first camshaft mounting location 322 is the same for the forward intake camshaft 702 and the forward exhaust camshaft 802 even though the head itself differs due to differing intake and exhaust positions. The second camshaft mounting location 324 is the same for the rearward intake camshaft 804 and the rearward exhaust camshaft 704. In other words, the first camshaft mounting location 322 and the second camshaft mounting location 324 can flip between intake and exhaust camshafts. For example, in the first cylinder head 302A, the forward intake camshaft 702 is positioned at the first camshaft mounting location 322 and the rearward exhaust camshaft 704 is positioned at the second camshaft mounting location 324. In second cylinder head 302B, the forward exhaust camshaft 802 is positioned at the first camshaft mounting location 322 and the rearward intake camshaft 804 is positioned at the second camshaft mounting location 324. Regardless of the intake or exhaust, the camshaft positions switch but the forward camshaft (no matter intake or exhaust) and rearward camshaft (no matter intake or exhaust) remain the same relative to the cam drive assembly (sprockets and chain) and remainder of the engine 300, including the cylinders 722, crankcase, etc.

To achieve such selective positioning on the first camshaft mounting location 322 and the second camshaft mounting location 324, the valve train assembly 502 is configured to have equal spacing or distance between the first camshaft 504 and the second camshaft 506. The valve train assembly 502 is configured to have equal spacing between the first camshaft 504 and the second camshaft 506 on the first camshaft mounting location 322 and the second camshaft mounting location 324, respectively, in the first cylinder head 302A and the second cylinder head 302B. In some embodiments, the forward intake camshaft 702 is separated from the rearward exhaust camshaft 704 by a first distance (D1). The forward exhaust camshaft 802 is separated from the rearward intake camshaft 804 by a second distance (D2) (seen e.g., in FIGS. 7 and 13). In some embodiments, the first distance (D1) between the forward intake camshaft 702 and rearward exhaust camshaft 704 in the first cylinder head 302A is the same as the second distance (D2) between the forward exhaust camshaft 802 and the rearward intake camshaft 804 in the second cylinder head 302B.

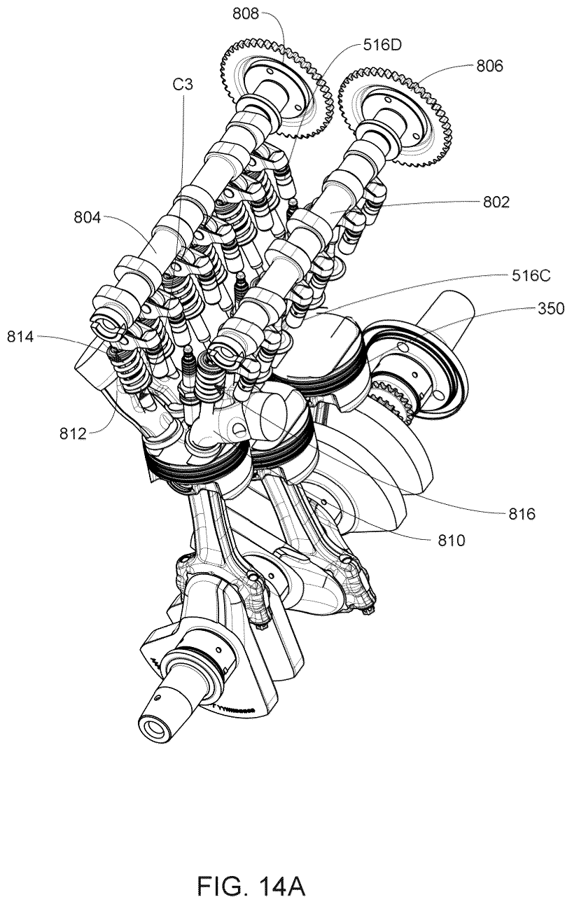

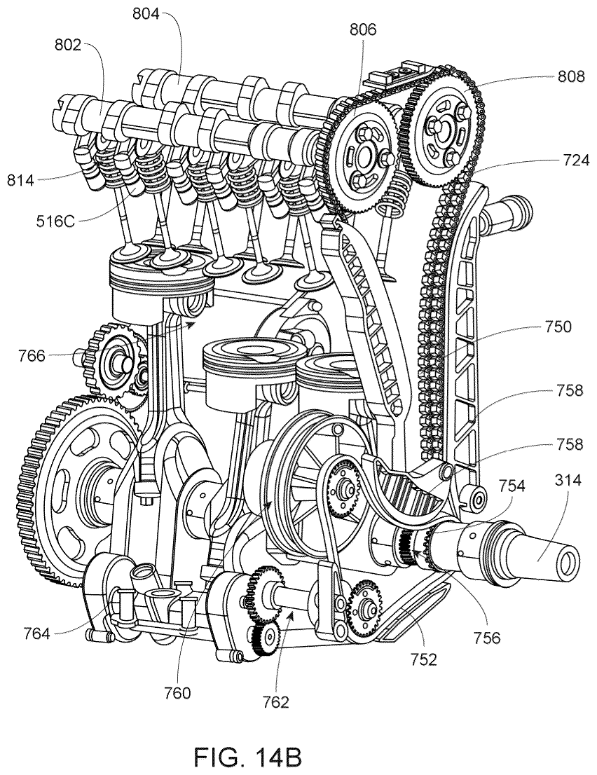

Thus, equal spacing and common mounting location of the first camshaft 504 and the second camshaft 506 enables for similar positioning of the first camshaft 504 and the second camshaft 506 in the first cylinder head 302A and the second cylinder head 302B. With such positioning, the same drive chain assembly 724 comprising a timing chain 750 and an auxiliary drive chain 752 can be used for either cylinder head, with the forward intake or the forward exhaust. In other words, the timing chain 750, the auxiliary drive chain 75, chain guides 758, timing chain sprocket 756, and an auxiliary drive chain sprocket 754 are the same for the cylinder head with the forward intake or the forward exhaust. It is to be noted that the timing chain 750 is configured to couple the crankshaft 314 with the first camshaft 504 and the second camshaft 506. The timing chain sprocket 756 on the crankshaft 314 is connected to corresponding sprockets on the first camshaft 504 and the second camshaft 506 via the timing chain 750. As the crankshaft 314 rotates, the crankshaft 314 drives the timing chain 750, which in turn rotates the first camshaft 504 and the second camshaft 506 at a proper timing. The auxiliary drive chain 752 is configured for operating an oil pump 762 and/or a coolant pump 760. The auxiliary drive chain sprocket 754 on the crankshaft 314 is connected to corresponding sprockets or gears on the oil pump 762 and the coolant pump 760. In addition, the same oil pump 762 and coolant pump 760 can be used for both cylinder head configurations. The same valve cover 312 and crankshaft 314 can also be used. In some embodiments, the same starter motor assembly 766 may be used for any engine configuration (seen e.g., in FIG. 14B).

In addition to equal spacing and common mounting location, relative positioning of the first camshaft 504 and the second camshaft 506 with respect to other engine assembly components including, but not limited to, the cylinders 722 or the drive chain assembly 724 are the same for the first cylinder head 302A and the second cylinder head 302B. It is to be noted that the arrangement or relative positioning implies the special relationship and orientation of the camshafts with other components. In some embodiments, relative positioning of the first camshaft 504 and the second camshaft 506 with respect to other components in the valve train assembly 502 are the same for the first cylinder head 302A and the second cylinder head 302B. In other words, arrangement of the first camshaft 504 and the second camshaft 506 with respect to other components in the valve train assembly 502 are the same for the first cylinder head 302A and the second cylinder head 302B. It is to be noted that the other components of the valve train assembly 502 includes valves 510, 512, finger followers 514, hydraulic compensators 516, and other associated parts. In some embodiments, relative positioning of the forward intake camshaft 702 and rearward exhaust camshaft 704 in the first cylinder head 302A is the same as the relative positioning of the forward exhaust camshaft 802 and the rearward intake camshaft 804 in the second cylinder head 302B.

As similar to the camshafts, relative positioning of the the finger followers 514 and the hydraulic compensators 516 with respect to other engine assembly components including, but not limited to, the cylinders 722 or the drive chain assembly 724 are the same for the first cylinder head 302A and the second cylinder head 302B. In some embodiments, relative positioning of the finger followers 514 and the hydraulic compensators 516 with respect to the other components in the valve train assembly 502 are the same for the first cylinder head 302A and the second cylinder head 302B. In other words, arrangement of the finger followers 514 and hydraulic compensators 516 of each camshaft 504, 506 with respect to other components in the valve train assembly 502 are the same for the first cylinder head 302A and the second cylinder head 302B.

In some embodiments, all the finger followers 514 are arranged at the same side (i.e., both on either the forward side or the rearward side) of each of the first camshaft 504 and the second camshaft 506 (seen e.g., in FIG. 5). In an illustrative example, all the finger followers 514 are arranged at the same side of each of the first camshaft 504 and the second camshaft 506 regardless of whether the intake and exhaust ports are positioned at the front or rear of the cylinder head 302. In some embodiments, the finger followers 514 are arranged at a first side (F3) or a second side (S3) of a rotational axis (FR1 and SR1) of each of the first camshaft 504 and the second camshaft 506. It is to be noted that “FR1” denotes a rotational axis of the first camshaft 504. “SR1” denotes a rotational axis of the second camshaft 506. The first side (F3) of the rotational axis (FR1 and SR1) of each of the first camshaft 504 and the second camshaft 506 corresponds to the front end (F1) of the vehicle 100. The second side (S3) of the rotational axis (FR1 and SR1) of each of the first camshaft 504 and the second camshaft 506 corresponds to the rear end (R1) of the vehicle 100. In one embodiment, the finger followers 514 are arranged at the first side (F3) of the rotational axis (FR1 and SR1) of each of the first camshaft 504 and the second camshaft 506 (not shown). In another embodiment, the finger followers 514 are arranged at the second side (S3) of the rotational axis (FR1 and SR1) of each of the first camshaft 504 and the second camshaft 506 (seen e.g., in FIGS. 5, 7, and 13). Preferably, the finger followers 514 are arranged at a rearward side (i.e., second side) of the rotational axis (FR1 and SR1) of each of the first camshaft 504 and the second camshaft 506. The rearward side of the rotational axis (FR1 and SR1) corresponds to the rear end (R1) of the vehicle 100 or the second side of the rotational axis (FR1 and SR1).

In some embodiments, all the hydraulic compensators 516 are arranged at the same side of each of the first camshaft 504 and the second camshaft 506 (seen e.g., in FIG. 5). Particularly, the hydraulic compensators 516 are arranged at an opposite side of the finger followers 514. In an illustrative example, all the hydraulic compensators 516 are arranged at the same side (i.e., both on either the forward side or the rearward side) of each of the first camshaft 504 and the second camshaft 506 regardless of whether the intake and exhaust ports are positioned at the front or rear of the cylinder head 302. In some embodiments, the hydraulic compensators 516 are arranged at the first side (F3) or the second side (S3) of the rotational axis (FR1 and SR1) of each of the first camshaft 504 and the second camshaft 506. In one embodiment, the hydraulic compensators 516 are arranged at the first side (F3) of the rotational axis (FR1 and SR1) of each of the first camshaft 504 and the second camshaft 506 if the finger followers 514 are arranged at the second side (S3) (seen e.g., in FIGS. 5, 7, and 13).

In another embodiment, the hydraulic compensators 516 are arranged at the second side (S3) of the rotational axis (FR1 and SR1) of each of the first camshaft 504 and the second camshaft 506 if the finger followers 514 are arranged at the first side (F3). Preferably, the hydraulic compensators 516 are arranged at first side of the rotational axis (FR1 and SR1) of each of the first camshaft 504 and the second camshaft 506. The first side of the rotational axis (FR1 and SR1) corresponds to the front end (F1) of the vehicle 100 or the first side of the rotational axis (FR1 and SR1). Accordingly, such arrangement of the finger followers 514 and the hydraulic compensators 516 offers a symmetric design for the first camshaft 504 and the second camshaft 506, thereby enabling to position the intake and exhaust ports on front or rear side of the cylinder head 302.

In some embodiments, the finger followers 514 include a plurality of first finger followers 514A and a plurality of second finger followers 514B. The hydraulic compensators 516 include a plurality of first hydraulic compensators 516A and a plurality of second hydraulic compensators 516B (seen e.g., in FIGS. 7, 9, 10, and 11). The first finger followers 514A, the second finger followers 514B, the first hydraulic compensators 516A, and the second hydraulic compensators 516B are configured to be positioned in the first cylinder head 302A with the at least one forward intake port 304 and the at least one rearward exhaust port 316. In an illustrative example, all the first finger followers 514A and second finger followers 514B are positioned at the same side of the forward intake camshaft 702 and rearward exhaust camshaft 704, respectively, in the first cylinder head 302A (seen e.g., in FIG. 7). In other words, the first finger followers 514A and second finger followers 514B are arranged or positioned at a first side (F3) or a second side (S3) of a rotational axis (IR1 and ER1) of the forward intake camshaft 702 and rearward exhaust camshaft 704, respectively. It is to be noted that “IR1” denotes a rotational axis of the forward intake camshaft 702. “ER1” denotes a rotational axis of the rearward exhaust camshaft 704. The first side (F3) of the rotational axis (IR1 and ER1) of each of the forward intake camshaft 702 and rearward exhaust camshaft 704 corresponds to the front end (F1) of the vehicle 100. The second side (S3) of the rotational axis (IR1 and ER1) of each of the forward intake camshaft 702 and rearward exhaust camshaft 704 corresponds to the rear end (R1) of the vehicle 100.

All first hydraulic compensators 516A and second hydraulic compensators 516B may be arranged at the same side of the forward intake camshaft 702 and rearward exhaust camshaft 704, respectively, preferably in front of the respective camshaft. Thus, the compensators 516A and 516B are also in front of the respective valves. While in the preferred embodiments, the first hydraulic compensators 516A and the second hydraulic compensators 516B are forward of the associated valves to which they are coupled, in alternate embodiments, the compensators may be positioned rearward of the associated valves.

In some embodiments, the finger followers 514 include a plurality of third finger followers 514C and a plurality of fourth finger followers 514D. The hydraulic compensators 516 include a plurality of third hydraulic compensators 516C and a plurality of fourth hydraulic compensators 516D (seen e.g., in FIGS. 13, 15, 16, and 17). The third finger followers 514C, the fourth finger followers 514D, the third hydraulic compensators 516C, and the fourth hydraulic compensators 516D are configured to be positioned in the second cylinder head 302B with the at least one rearward intake port 404 and at least one forward exhaust port 402. All the third finger followers 514C and fourth finger followers 514D may be positioned at the same side of the forward exhaust camshaft 802 and rearward intake camshaft 804, respectively, in the second cylinder head 302B (seen e.g., in FIG. 13). In other words, the third finger followers 514C and the fourth finger followers 514D are arranged or positioned at a first side (F3) or a second side (S3) of a rotational axis (ER2 and IR2) of the forward exhaust camshaft 802 and rearward intake camshaft 804, respectively. It is to be noted that “IR2” denotes a rotational axis of the rearward intake camshaft 802. “ER2” denotes a rotational axis of the forward exhaust camshaft 804. The first side (F3) of the rotational axis (ER2 and IR2) of each of the forward exhaust camshaft 802 and rearward intake camshaft 804 corresponds to the front end (F1) of the vehicle 100. The second side (S3) of the rotational axis (ER2 and IR2) of each of the forward exhaust camshaft 802 and rearward intake camshaft 804 corresponds to the rear end (R1) of the vehicle 100.

As similar to the camshafts 504, 506, the positioning of the valves, finger followers, and hydraulic compensators remains the same with respect to the camshafts, cam drive assembly, cylinders, and crankcase. Thus, while the forward valves may be either intake or exhaust valves, their position relative to the remainder of the engine remains the same for the first cylinder head 302A and the second cylinder head 302B.

In some embodiments, the intake valves 510 include a plurality of first intake valves 714. The exhaust valves 512 include a plurality of first exhaust valves 716 (seen e.g., in FIGS. 7, 8, 9, 10, and 11). The plurality of first intake valves 714 and the plurality of first exhaust valves 716 are configured to be positioned in the first cylinder head 302A with the at least one forward intake port 304 and the at least one rearward exhaust port 316. The first intake valves 714 are configured to be associated with the forward intake camshaft 702. The first exhaust valves 716 are configured to be associated with the rearward exhaust camshaft 704. A valve spring 718 partially encloses the first intake valves 714. A valve spring 720 partially encloses the first exhaust valves 716. In some embodiments, the intake valves 510 include a plurality of second intake valves 814. The exhaust valves 512 include a plurality of second exhaust valves 816 (seen e.g., in FIGS. 13, 14A, 15, 16, and 17). The plurality of second intake valves 814 and the plurality of second exhaust valves 816 are configured to be positioned in the second cylinder head 302B with the at least one rearward intake port 404 and at least one forward exhaust port 402. The second intake valves 814 are configured to be associated with the rearward intake camshaft 804. The second exhaust valves 816 are configured to be associated with the forward exhaust camshaft 802. A valve spring 818 partially encloses the second exhaust valves 816. A valve spring 820 partially encloses the second intake valves 814.

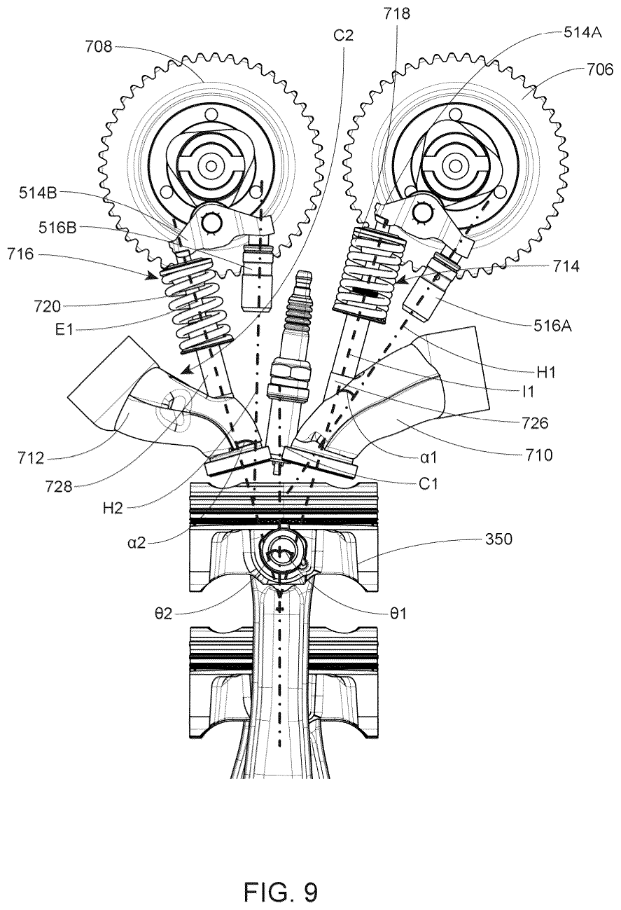

Preferably, each of the intake valves 714, 814 and the exhaust valves 716, 816 are angled with respect to a central axis (C1) of each cylinder 722 (seen e.g., in FIGS. 9, 15, and 16). It is to be noted that the central axis (C1) of each cylinder 722. In other words, each of the intake valves 714, 814 and the exhaust valves 716, 816 are arranged such that a corresponding intake valve axis and exhaust valve axis are inclined relative to the central axis (C1) of each cylinder 722 by a predetermined angle. It is to be noted that the intake valve axis is an imaginary line passing through the center of each intake valve. Similar to the intake valve axis, the exhaust valve axis is an imaginary line passing through the center of each exhaust valve. In some embodiments, an angle of the intake valves with respect to the central axis (C1) of each cylinder 722 and an angle of the exhaust valves with respect to the central axis (C1) of each cylinder 722 are the same. In some embodiments, the angle of the intake valves with respect to the central axis (C1) of each cylinder 722 and the angle of the exhaust valves with respect to the central axis (C1) of each cylinder 722 are different.

Each first intake valve 714 is positioned such that a corresponding intake valve axis (I1) is inclined relative to the central axis (C1) of each cylinder 722 by a first angle (θ1). Each first exhaust valve 716 is positioned such that a corresponding exhaust valve axis (E1) is inclined relative to the central axis (C1) of each cylinder 722 by a second angle (θ2) (seen e.g., in FIG. 9). In some embodiments, the first angle (θ1) and the second angle (θ2) are the same. In some embodiments, the first angle (θ1) and the second angle (θ2) are different.

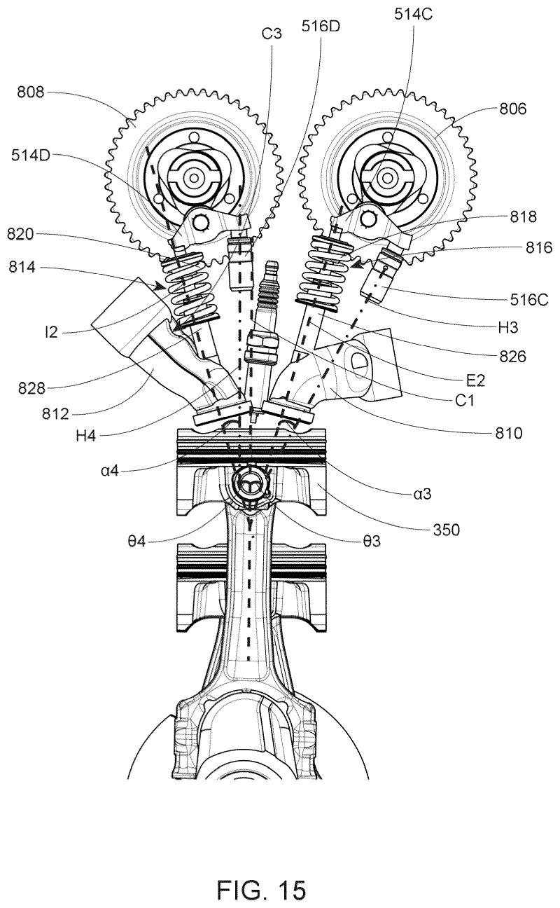

Each second exhaust valve 816 is positioned such that a corresponding exhaust valve axis (E2) is inclined relative to the central axis (C1) of each cylinder 722 by a third angle (θ3). Each intake valve 814 is positioned such that a corresponding intake valve axis (I2) is inclined relative to the central axis (C1) of each cylinder 722 by a fourth angle (θ4) (seen e.g., in FIG. 15). In some embodiments, the third angle (θ3) and the fourth angle (θ4) are the same. In some embodiments, the third angle (θ3) and the fourth angle (θ4) are different.

In some embodiments, the intake valves 714, 814 are larger than the exhaust valves 716, 816. As seen FIG. 9, each first intake valve 714 is larger than each first exhaust valve 716. Similarly, each second intake valve 814 is larger than each second exhaust valve 816 (seen e.g., in FIG. 15). Such that, for positioning intake valves 714, 814, exhaust valves 716, 816, and corresponding compensators in two different cylinder heads, the positioning of the intake valves 714, 814, exhaust valves 716, 816, and corresponding compensators 516 are slightly different, including angles of the valve stems and compensators. Such slight difference in positioning is due to the larger intake valves and to avoid positioning the intake valves 714, 814, exhaust valves 716, 816, and compensators 516 out of the way of the intake and exhaust channels, especially the exhaust channels as this helps to avoid heat.

In some embodiments, the hydraulic compensators 516 and corresponding valve stems of each of the intake valves 510 and the exhaust valves 512 are non-parallel to each other (seen e.g., in FIGS. 9 and 15). In other words, the hydraulic compensators 516 are angled with corresponding valve stems of the intake valves 510 and the exhaust valves 512. Each of the intake valves 510 and the exhaust valves 512 and corresponding hydraulic compensator 516 are arranged such that a corresponding hydraulic compensator axis is inclined relative to a corresponding intake valve axis and exhaust valve axis by a predetermined angle. Such that, the hydraulic compensators 516 are packed in a space-efficient manner. The hydraulic compensator axis refers to an imaginary line passing through the center of each of the hydraulic compensators 516.

In some embodiments, each first hydraulic compensator 516A and a corresponding valve stem 726 of each of the first intake valves 714 are non-parallel to each other. Each second hydraulic compensator 516B and a corresponding valve stem 728 of each of the first exhaust valves 716 are non-parallel to each other (seen e.g., in FIG. 9). Each of the first intake valves 714 and the first hydraulic compensators 516A are arranged such that a corresponding hydraulic compensator axis (H1) is inclined relative to the corresponding intake valve axis (I1) by a fifth angle (α1). Each of first exhaust valves 716 and the second hydraulic compensators 516B are arranged such that a corresponding hydraulic compensator axis (H2) is inclined relative to the corresponding exhaust valve axis (E1) by a sixth angle (α2). In some embodiments, the fifth angle (α1) and the sixth angle (α2) are the same. In some embodiments, the fifth angle (α1) and the sixth angle (α2) are different. In an illustrative example, the fifth angle (α1) and the sixth angle (α2) are both acute angles. In an illustrative example, the hydraulic compensator axis (H1) intersects the corresponding intake valve axis (I1) above the piston 350 when the piston 350 is positioned at top dead center, and in addition to, or alternatively, the hydraulic compensator axis (H2) intersects the corresponding intake valve axis (E1) at or above the piston 350 when the piston 350 is positioned at top dead center.

In some embodiments, each third hydraulic compensator 516C and a corresponding valve stem 826 of each of the second exhaust valves 816 are non-parallel to each other. Each fourth hydraulic compensators 516D and a corresponding valve stem 828 of each of the second intake valves 814 are non-parallel to each other (seen e.g., in FIG. 15). Each of the second exhaust valves 816 and third hydraulic compensators 516C are arranged such that a corresponding hydraulic compensator axis (H3) is inclined relative to the corresponding exhaust valve axis (E2) by a seventh angle (α3). Each of second intake valves 814 and fourth hydraulic compensators 516D are arranged such that a corresponding hydraulic compensator axis (H4) is inclined relative to the corresponding intake valve axis (I2) by an eighth angle (α4). In some embodiments, the seventh angle (α3) and the eighth angle (α4) are the same. In some embodiments, the seventh angle (α3) and the eighth angle (α4) are different. In an illustrative example, the seventh angle (α3) and the eighth angle (α4) are both acute angles. In an illustrative example, the hydraulic compensator axis (H3) intersects the corresponding exhaust valve axis (E2) at or above the wrist pin of the piston 350 when the piston 350 is positioned at top dead center, and in addition to, or alternatively, the hydraulic compensator axis (H4) intersects the corresponding intake valve axis (I2) at or above the wrist pin of the piston 350 when the piston 350 is positioned at top dead center

In some embodiments, the hydraulic compensators 516 are positioned to accommodate either an adjacent exhaust channel or an adjacent inlet channel depending on the cylinder head selected. In an illustrative example, the adjacent exhaust channel or the adjacent inlet channel may be routed through the cylinder head selected. This positions the hydraulic compensator 516 a greater distance away from an adjacent exhaust channel of a first cylinder head 302A configuration than from an adjacent inlet channel of a second cylinder head 302B configuration. Thus, the hydraulic compensators 516 are distanced from the heat of the gases flowing in the exhaust channels.

Routing of the adjacent exhaust channel or the adjacent inlet channel to accommodate the location of the hydraulic compensator allows for two different inlet and exhaust configurations to be used without modifying the location of the hydraulic valve compensator and increasing the overall size of the engine assembly. Accordingly, proper valve lash adjustment is maintained by the hydraulic compensators 516 for both the first cylinder head 302A and the second cylinder head 302B configurations. In a non-limiting example, the inlet channels include a plurality of first inlet channels 710 and a plurality of second inlet channels 812. The exhaust channels include a plurality of first exhaust channels 712 and a plurality of second exhaust channels 810. The first inlet channels 710 and the first exhaust channels 712 correspond to the first cylinder head 302A (seen e.g., in FIGS. 7, 8, 9, 10, and 11). The second inlet channels 812 and the second exhaust channels 810 correspond to the second cylinder head 302B (seen e.g., in FIGS. 13, 14A, 15, 16 and 17).

In one embodiment, the first inlet channel 710 of the first cylinder head 302A is positioned at a third distance from the first hydraulic compensators 516A. The first exhaust channel 712 of the first cylinder head 302A is positioned at a fourth distance from the second hydraulic compensators 516B (seen e.g., in FIGS. 7, 8, 9, 10, and 11). In another embodiment, the second exhaust channel 810 of the second cylinder head 302B is positioned at a fifth distance from the third hydraulic compensators 516C. The second inlet channel 812 of the second cylinder head 302B is positioned at a sixth distance from the fourth hydraulic compensators 516D (seen e.g., in FIGS. 13, 14A, 15, 16, and 17). The third distance is less than the fifth distance. Thus, the first hydraulic compensators 516A are positioned closer to an end of the first inlet channel 710 positioned adjacent the intake port 304 of the first cylinder head 302A than the third hydraulic compensators 156C are to an end of the second exhaust channel 810 positioned adjacent the exhaust port 402 of the second cylinder head 302B. In addition to, or alternatively, the fourth distance is greater than the sixth distance such that the second hydraulic compensators 516B are positioned farther from an end of the first exhaust channel 712 positioned adjacent the exhaust port 304 of the first cylinder head 302A than the fourth hydraulic compensators 156D are to an end of the second inlet channel 812 positioned adjacent the intake port 402 of the second cylinder head 302B.

In some embodiments, driven by slight difference in positioning of intake valves 714, 814, exhaust valves 716, 816 in the first cylinder head 302A and the second cylinder head 302B, the other elements such as compensators 516, coolant passages are positioned slightly differently out of the way of the intake and exhaust channels. Positioning away from the exhaust channels helps to avoid heat. Heat is also dealt with by having a portion of coolant jacket between or adjacent the exhaust channels and the valves and/or other components. In such different positioning, the intake valves 714, 814, exhaust valves 716, 816, and compensators 516 are positioned out of the way of the coolant passages of corresponding cylinder head.

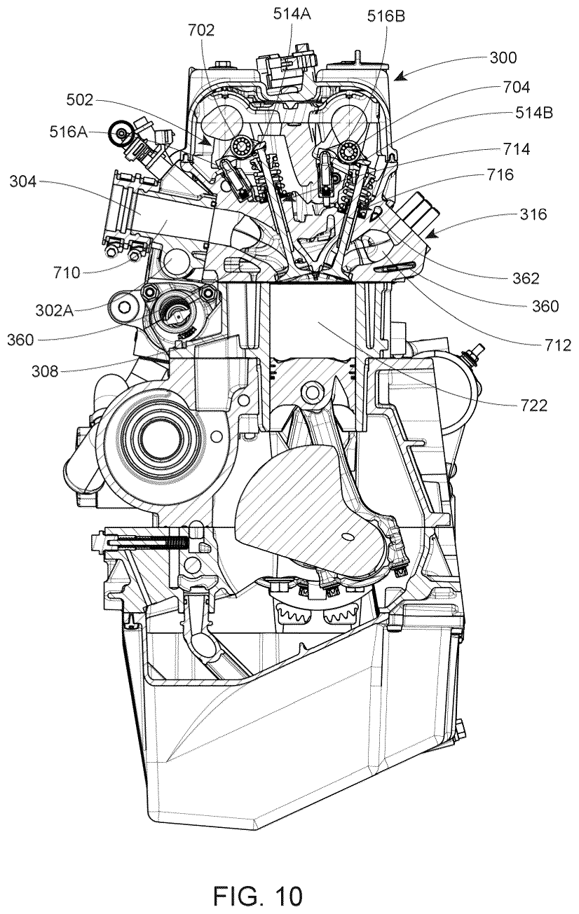

As seen in FIG. 10, the first cylinder head 302A with forward intake ports 304 includes a first coolant passage 360 and a second coolant passage 362. The first coolant passage 360 is configured to surround outer peripheries of the forward intake ports 304 and the rearward exhaust ports 316 in the vicinity of the periphery of the combustion chamber of each cylinder 722. In other words, the first coolant passage 360 is formed below the inlet and exhaust channels of the first cylinder head 302A. The second coolant passage 362 is configured to be formed on the upper side of the exhaust channels of the first cylinder head 302A. The intake valves 714, the exhaust valves 716, the first compensators 516A and the second compensators 516B are positioned out of the way of the first coolant passage 360 and the second coolant passage 362.

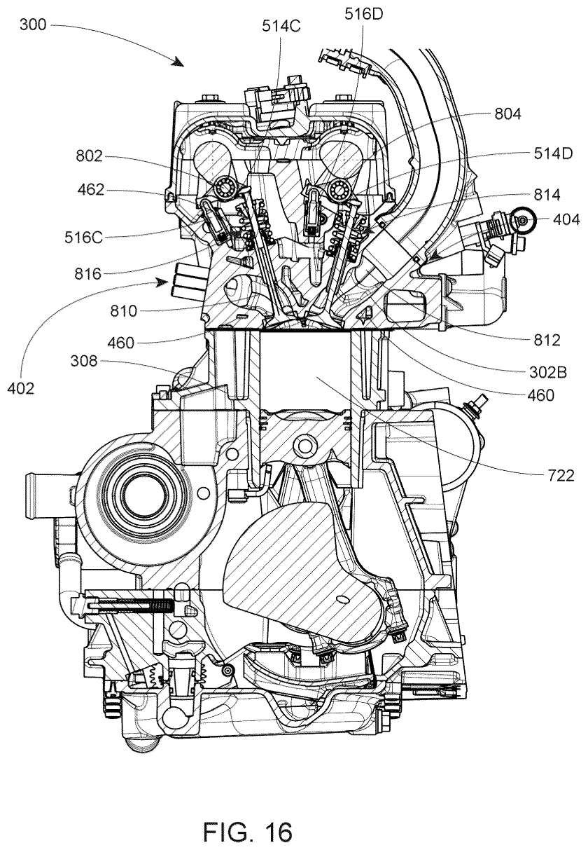

As seen in FIG. 16, the second cylinder head 302B with forward exhaust ports 402 includes a third coolant passage 460 and a fourth coolant passage 462. The third coolant passage 460 is configured to surround outer peripheries of the forward exhaust ports 402 and the rearward intake ports 404 in the vicinity of the periphery of the combustion chamber of each cylinder 722. In other words, the third coolant passage 460 is formed below the inlet channels and exhaust channels of the second cylinder head 302B. The fourth coolant passage 462 is configured to be formed on the upper side of the exhaust channels of the second cylinder head 302B. The intake valves 814, the exhaust valves 816, the third compensators 516C and the fourth compensators 516D are positioned out of the way of the third coolant passage 460 and the fourth coolant passage 462. Due to slightly different positioning of the intake valves 714, 814 and the exhaust valves 716 and 816, the first coolant passage 360 in the first cylinder head 302A and the third coolant passage 460 in the second cylinder head 302B are positioned slightly differently. Similarly, due to slightly different positioning of the intake valves 714, 814 and the exhaust valves 716 and 816, the second coolant passage 362 in the first cylinder head 302A and the fourth coolant passage 462 in the second cylinder head 302B are positioned slightly differently.

One end 317A of each of the first inlet channels 710 opens in the combustion chamber of each cylinder 722 and another end 317B of each of the first inlet channels 710 opens in an outer face of the first cylinder head 302A. One end 315A of each of the first exhaust channels 712 opens in the combustion chamber of each cylinder 722 and another end 315B of each of the first exhaust channels 712 opens in an outer face of the first cylinder head 302A (seen e.g., in FIG. 12). At least one portion of each of the first inlet channels 710 branches into the two inlet passages which open in the combustion chamber of each cylinder 722. At least one portion of each of the first exhaust channels 712 branches into the two exhaust passages which open in the combustion chamber of each cylinder 722. Such that each of the first inlet channels 710 and the first exhaust channels 712 comprise a branched portion 309, 305 and a straight portion 311, 307. One end 405A of each of the second exhaust channel 810 opens in the combustion chamber of each cylinder 722 and another end 405B of each of the second exhaust channels 810 opens in an outer face of the second cylinder head 302B. One end 403A of each of the second inlet channel 812 opens in the combustion chamber of each cylinder 722 and another end 403B of each of the second inlet channel 812 opens in an outer face of the second cylinder head 302B (seen e.g., in FIG. 18). At least one portion of each of the second inlet channels 812 branches into the two inlet passages which open in the combustion chamber of each cylinder 722. At least one portion of each of the second exhaust channel 810 branches into the two exhaust passages which open in the combustion chamber of each cylinder 722. Such that each of the second inlet channel 812 and the second exhaust channel 810 comprise a branched portion 408, 410 and a straight portion 409, 411.

In some embodiments, the inlet channel of the cylinder head 302 with forward intake ports is substantially straight due to space availability in particulars applications. For example, the forward intake ports on a side-by-side vehicle 100 can be straight and avoid sharp bends as space forward of the cylinders is available. Routing is optimized to avoid unnecessary bends for flow optimization. Routing is also arranged to avoid unnecessary heat exposure to components such as hydraulic compensators. Thus, in some embodiments, the exhaust channel of the cylinder head 302 with rearward exhaust ports is not straight. In some embodiments, the exhaust channel of the cylinder head 302 with forward exhaust ports is substantially straight. Conversely, the inlet channel of the cylinder head 302 with rearward intake ports is not straight. In one embodiment, the first inlet channels 710 of the first cylinder head 302A are substantially straight. The first exhaust channels 712 of the first cylinder head 302A are not straight. In other words, a first flow path (IF1) of the first inlet channels 710 of the first cylinder head 302A is substantially straight with respect to a split axis (SA) separating the first cylinder head 302A and the cylinder block 308. It is to be noted that the split axis (SA) is perpendicular to the central axes of the cylinders 722 of the engine. A second flow path (EF1) of the first exhaust channels 712 of the first cylinder head 302A is not straight with respect to the split axis (SA) separating the first cylinder head 302A and the cylinder block 308 (seen e.g., in FIG. 11). In another embodiment, the second inlet channels 812 of the second cylinder head 302B are not straight. The second exhaust channels 810 of the second cylinder head 302B are substantially straight. In other words, a third flow path (EF2) of the second exhaust channels 810 of the second cylinder head 302B is substantially straight with respect to a split axis (SA) separating the second cylinder head 302B and the cylinder block 308. A fourth flow path (IF2) of the second inlet channels 812 of the second cylinder head 302B is not straight with respect to the split axis (SA) separating the second cylinder head 302B and the cylinder block 308 (seen e.g., in FIG. 17).

In some embodiments, the length of the exhaust channel of the cylinder head 302 with either forward intake ports and rearward exhaust ports or rearward intake ports and forward exhaust ports, is shorter with respect to the inlet channel of the cylinder head 302, thereby reducing heat generated by the exhaust channel. For example, the first exhaust channels 712 of the first cylinder head 302A have a shorter length than the first inlet channels 710 of the first cylinder head 302A. The second exhaust channels 810 of the second cylinder head 302B are have a shorter length than the second inlet channels 812 of the second cylinder head 302B.

In some embodiments, each of the first exhaust channels 712 of the first cylinder head 302A with rearward exhaust ports 316 is configured to have a first curved portion (C2) to accommodate a corresponding valve spring 720 of each of the plurality of first exhaust valves 716, thereby enabling space efficient packaging of the one or more components of the valve train assembly 502 in the first cylinder head 302A (seen e.g., in FIG. 9). In some embodiments, the branched portion of the first exhaust channel 712 (seen e.g., in FIG. 12) comprises the first curved portion (C2) in an inner side 319 of the first exhaust channel 712. In some embodiments, each of the second inlet channels 812 of the second cylinder head 302B with rearward intake ports 404 is configured to have a second curved portion (C3) to receive or otherwise accommodate valve spring 820 of each of the plurality of second intake valves 814, thereby enabling space-efficient packaging of the one or more components of the valve train assembly 502 in the second cylinder head 302B (seen e.g., in FIG. 15). In some embodiments, the branched portion of the second inlet channels 812 comprises the second curved portion (C3) in an inner side 407 (seen e.g., in FIG. 18) of the second inlet channel 812. The first curved portion (C2) of the first exhaust channel 712 of the first cylinder head 302A is different from the second curved portion (C3) of the second inlet channel 812 of the second cylinder head 302B.

Due to symmetrical positioning of the camshafts 504, 506, finger followers 514, hydraulic compensators 516, and valves 510, 512, cam profiles of the first camshaft 504 and the second camshaft 506 may be the same. In some embodiments, cam profiles of the first camshaft 504 and the second camshaft 506 are different to tune for specific performance objectives. The cam profiles of the first camshaft 504 and the second camshaft 506 are decided by a valve lift curve and geometry of one or more components of the engine 300 one to another. These considerations and options also exist for the other embodiments shown and described, including the camshafts 702, 704 and 802, 804.

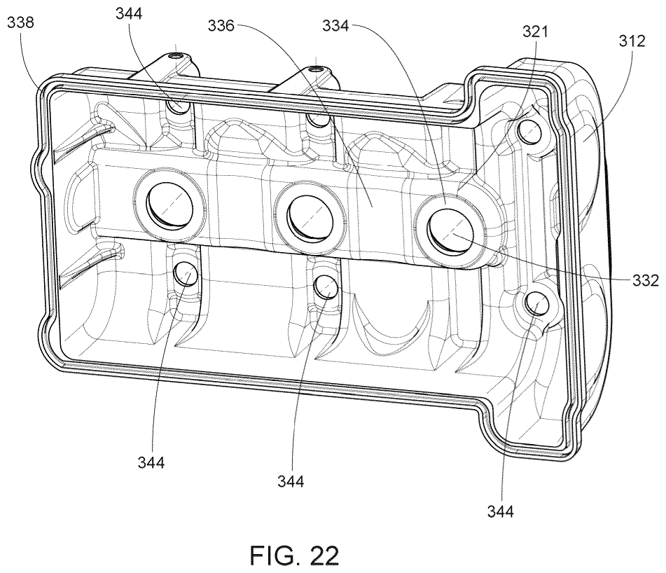

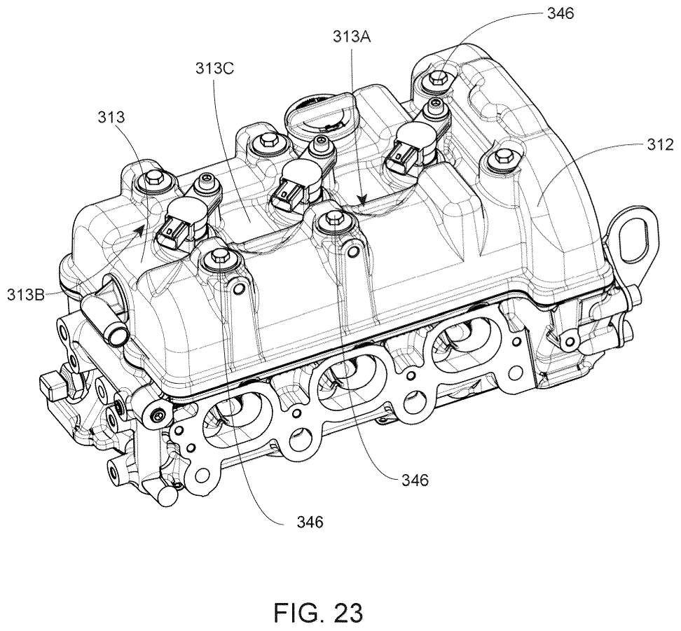

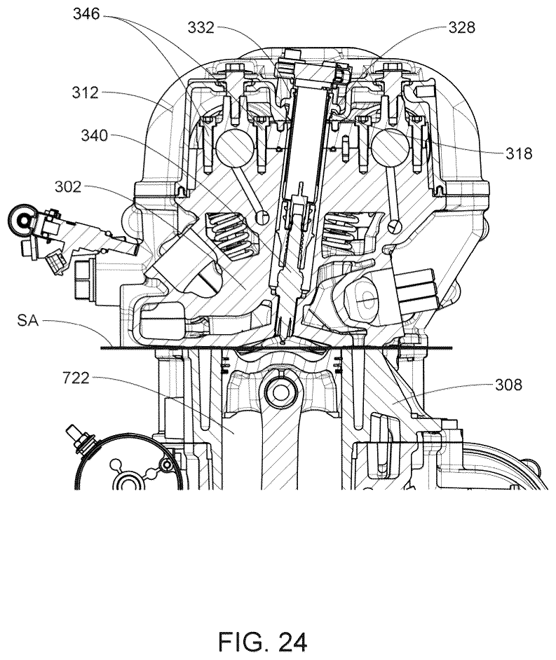

Now referring to FIGS. 19-24, the cylinder head 302 comprises at least one first opening 318 on top of the cylinder head 302 for receiving at least one spark plug 340. In some embodiments, each of the first cylinder head 302A and the second cylinder head 302B comprises at least one first opening 318. The valve cover 312 comprises at least one second opening 332 extending from an exterior surface to an interior surface as shown in FIGS. 22 and 23. In some embodiments, the valve cover 312 comprises a center portion 313. The center portion 313 comprises a first side wall 313A, a second side wall 313B, and a flat surface 313C between the first side wall 313A and the second side wall 313B. The first side wall 313A and the second side wall 313B extending downwardly towards to a surface of the cylinder head 302 and forms a lower projecting ridge 321 along with the interior side of the flat surface 313C. The at least one second opening 332 is positioned in the flat surface 313C of the center portion 313 (seen e.g., in FIGS. 22 and 23). The at least one second opening 332 is aligned with the first opening 318 of the cylinder head 302 for inserting at least spark plug 340 through the second opening 332 from the exterior of the valve cover 312 and into the at least one first opening 318 of the cylinder head 302, thereby a lower end of the at least one spark plug 340 is exposed to the combustion chamber at a top of each cylinder 722 of the engine 300 (seen e.g., in FIG. 24). In some embodiments, the at least one spark plug 340 is angled with respect to the split axis (SA) separating the first cylinder head 302 and the cylinder block 308.

In some embodiments, the cylinder head 302 defines a recess 320 surrounding a perimeter of the at least one first opening 318 of the cylinder head 302 for receiving a seal 328 that abuts the cylinder head 302 and the valve cover 312. A flat bottom of the recess 320 is positioned at a seventh distance from a top edge of the recess 320. Accordingly, each of the first cylinder head 302A and the second cylinder head 302B comprises a recess 320 surrounding a perimeter of the at least one first opening 318 (seen e.g., in FIGS. 19 and 20).

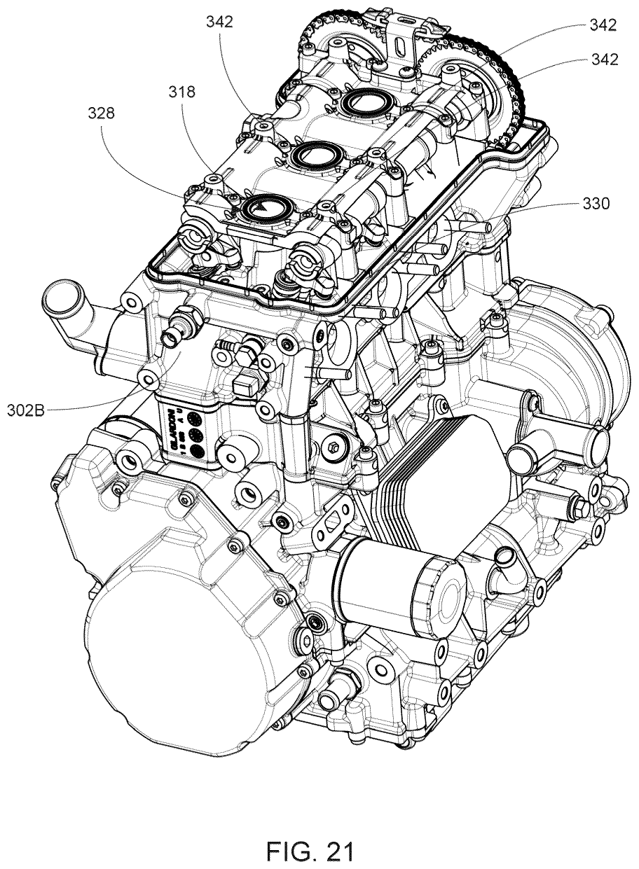

In some embodiments, the valve cover 312 comprises a first seal 328 for providing sealing between the at least one first opening 318 of the cylinder head 302 and the at least one second opening 332 of the valve cover 312. The first seal 328 is configured to be positioned in the recess 320 of the cylinder head 302 (seen e.g., in FIG. 21). An interior surface of the valve cover 312 comprises a flat surface 334 surrounding a bottom of the at least one second opening 332 for interfacing with a flat top surface of the first seal 328 of the valve cover 312 (seen e.g., in FIG. 22). In other words, the valve cover 312 comprises a flat ring-shaped surface 334, in the lower projecting ridge 321, surrounding a bottom of the at least one second opening 332. The surface 334 preferably projects slightly downwardly from ridge 321. The ridge provides support to keep the surface 334 flat and aligned with seal 328 for good sealing engagement therewith.

The valve cover 312 comprises a groove 338 along a bottom edge of the valve cover 312 surrounding a perimeter of the valve cover 312 (seen e.g., in FIG. 22). The groove 338 is configured to receive a second seal 330 for providing sealing between the valve cover 312 and the cylinder head 302. In some embodiments, the valve cover 312 comprises at least one convex portion 336 at a bottom surface that is configured to align with at least one concave portion 326 on top of the cylinder head 302 to define a gap therebetween, thereby preventing vibration between the valve cover 312 and the cylinder head 302. In some embodiments, the first seal 328 and the second seal 330 are made of a soft, elastomeric material. In some embodiments, the soft material is rubber. In some embodiments, the valve cover 312 is produced using a die casting. Preferably, the valve cover 312 is de-coupled from the cylinder head in that at all fastening and contact locations an elastomeric seal or washer is used. This fastening arrangement helps improve NVH (noise, vibration, and harshness).

The arrangement of the valve cover 312 and seal 328 help to simplify cover installation and avoid misalignment of seals. Seal 328 is secured within the recess 320 in the top of cylinder head 302. Thus, when valve cover 312 is positioned in place on top of cylinder head 302, the installer can easily ascertain that the seals are in place and gravity helps hold them there in the recesses. The installer can then fasten the valve cover 312 in place using one or more fasteners 346. The one or more fasteners 346 are threaded through aligned holes 342, 344 in the cylinder head 302 and the valve cover 312, respectively for precise alignment between the cylinder head 302 and the valve cover 312.

The present disclosure also sets forth a method of installing the engine assembly 102 in the vehicle 100 using any one of two different cylinder heads. The method includes installing the cylinder head 302 selected from the first cylinder head 302A or the second cylinder head 302B on the engine block 306 and installing the valve train assembly 502 in the cylinder head 302. Regardless of a type of cylinder head selected, the valve cover 312, the drive chain assembly 724 (guides, chain, sprockets), cylinders 722, cylinder block 308, crankshaft 314, crankcase 310, oil pump 762, and coolant pump 760 are same for the first cylinder head 302A and the second cylinder head 302B.

It is to be noted that different values and parameters mentioned in the description are exemplary in nature and are not intended to bound the specification in any manner.

Finally, while the present invention has been described above with reference to various exemplary embodiments, many changes, combinations, and modifications may be made to the exemplary embodiments without departing from the scope of the present invention. For example, the various components may be implemented in alternative ways. These alternatives can be suitably selected depending upon the particular application or in consideration of any number of factors associated with the operation of the device. In addition, the techniques described herein may be extended or modified for use with other types of devices. These and other changes or modifications are intended to be included within the scope of the present invention.

1. An engine assembly of an off-road vehicle extending from a front end to a rear end in a longitudinal direction, the engine assembly comprising:
an engine comprising:
a cylinder head; and
a valve train assembly comprising a first camshaft and a second camshaft, the valve train assembly is configured to position the first camshaft and the second camshaft such that the cylinder head from a first cylinder head or a second cylinder head having a different configuration than the first cylinder head is selected,
wherein a first camshaft position and a second camshaft position are the same for the first cylinder head and the second cylinder head.

2. The engine assembly of claim 1, wherein the first camshaft is selected from a forward intake camshaft or a forward exhaust camshaft; and the second camshaft is selected from a rearward intake camshaft or a rearward exhaust camshaft, wherein the first cylinder head is configured to receive the forward intake camshaft and the rearward exhaust camshaft; the second cylinder head is configured to receive the rearward intake camshaft and the forward exhaust camshaft.

3. The engine assembly of claim 1, wherein the first cylinder head comprises at least one forward intake port and at least one rearward exhaust port; and the second cylinder head comprises at least one rearward intake port and at least one forward exhaust port, wherein the first cylinder head comprises at least one first inlet channel corresponding to the at least one forward intake port and at least one first exhaust channel corresponding to the at least one rearward exhaust port; and the second cylinder head comprises at least one second inlet channel corresponding to the at least one rearward intake port; and at least one second exhaust channel corresponding to the at least one forward exhaust port.

4. The engine assembly of claim 2, wherein the valve train assembly is configured to position the first camshaft and the second camshaft at a first camshaft mounting location and a second camshaft mounting location, respectively, in the cylinder head, wherein the first camshaft mounting location is the same for the forward intake camshaft and the forward exhaust camshaft; and the second camshaft mounting location is the same for the rearward intake camshaft and the rearward exhaust camshaft.

5. The engine assembly of claim 4, wherein the valve train assembly is configured to have equal spacing between the first camshaft and the second camshaft on the first camshaft mounting location and the second camshaft mounting location, respectively, in the first cylinder head and the second cylinder head.

6. The engine assembly of claim 2, wherein the forward intake camshaft is separated from the rearward exhaust camshaft by a first distance; and the forward exhaust camshaft is separated from the rearward intake camshaft by a second distance, wherein the first distance and the second distance are the same.

7. The engine assembly of claim 1, wherein relative positioning of the first camshaft and the second camshaft with respect to cylinders or a drive chain assembly are the same for the first cylinder head and the second cylinder head.

8. The engine assembly of claim 1, wherein the valve train assembly further comprises a plurality of finger followers and a plurality of hydraulic compensators, wherein relative positioning of the finger followers and hydraulic compensators with respect to cylinders or a drive chain assembly are the same for the first cylinder head and the second cylinder head.

9. The engine assembly of claim 8, wherein the finger followers are arranged at the same side of each of the first camshaft and the second camshaft; and the hydraulic compensators are arranged at an opposite side of the finger followers.

10. The engine assembly of claim 8, wherein the valve train assembly further comprises a plurality of intake valves and a plurality of exhaust valves, wherein relative positioning of the intake valves and the exhaust valves with respect to cylinders or a drive chain assembly are the same for the first cylinder head and the second cylinder head.

11. The engine assembly of claim 10, wherein the hydraulic compensators and corresponding valve stems of each of the plurality of intake valves and the plurality of exhaust valves are non-parallel to each other.

12. The engine assembly of claim 8, wherein the hydraulic compensators are configured to positioned away from inlet channels and exhaust channels of the cylinder head.

13. The engine assembly of claim 3, wherein the at least one first inlet channel of the first cylinder head is substantially straight; and the at least one second exhaust channel of the second cylinder head is substantially straight, wherein a first flow path of the at least one first inlet channel of the first cylinder head is substantially straight with respect to a split axis separating the first cylinder head and the cylinder block; and a third flow path of the at least one second exhaust channel of the second cylinder head is substantially straight with respect to a split axis separating the second cylinder head and the cylinder block.

14. The engine assembly of claim 3, wherein the at least first exhaust channel of the first cylinder head is configured to have a first curved portion to accommodate a corresponding valve spring of a corresponding exhaust valve.

15. The engine assembly of claim 14, wherein the at least one second inlet channel of the second cylinder head is configured to have a second curved portion to accommodate a corresponding valve spring of a corresponding intake valve, wherein the first curved portion of the first cylinder head and the second curved portion of the second cylinder head are different.

16. The engine assembly of claim 3, wherein the at least first exhaust channel of the first cylinder head and the at least one second exhaust channel of the second cylinder head are short with respect to corresponding inlet channels.

17. The engine assembly of claim 1, wherein cam profiles of the first camshaft and the second camshaft are decided by a valve lift curve and geometry of one or more components of the engine one to another.

18. The engine assembly of claim 1, wherein the engine further comprises a valve cover that is configured to be mounted on top of the cylinder head for housing the valve train assembly, wherein the valve cover is the same for the first cylinder head and the second cylinder head.

19. The engine assembly of claim 1, wherein the engine comprises a drive chain assembly that is configured for providing rotational movement from a crankshaft to each of the first camshaft and the second camshaft for opening and closing each of a plurality of intake valves and a plurality of exhaust valves, wherein the drive chain assembly is the same for the first cylinder head and the second cylinder head.

20. An engine assembly of an off-road vehicle extending from a forward end to a rearward end in a longitudinal direction, the engine assembly comprising:
an engine comprising:
a cylinder head; and
a valve train assembly comprising:
a forward camshaft;
a rearward camshaft;
at least one forward valve with a valve spring;
at least one rearward valve with a valve spring; and
at least one forward hydraulic compensator coupled to the at least one forward valve;
at least one rearward hydraulic compensator coupled to the at least one rearward valve;
wherein the forward and rearward valves are positioned either both forward of the coupled compensators or both rearward of the coupled compensators.

21. The engine assembly of claim 20, wherein the finger followers are arranged at a first side or a second side of a rotational axis of each of the first camshaft and the second camshaft, wherein the first side of the rotational axis of each of the first camshaft and the second camshaft corresponds to the front end of the vehicle; and the second side of the rotational axis of each of the first camshaft and the second camshaft corresponds to the rear end of the vehicle.

22. The engine assembly of claim 20, wherein the finger followers are arranged rearward of the hydraulic compensators.

23. The engine assembly of claim 20, wherein the hydraulic compensators are configured to be positioned away from inlet channels and exhaust channels of the cylinder head.

24. The engine assembly of claim 20, wherein the hydraulic compensators and corresponding valve stems of each of a plurality of intake valves and a plurality of exhaust valves are non-parallel to each other.

25. The engine assembly of claim 24, wherein each of the hydraulic compensator is angled with a corresponding valve stem of a corresponding intake valve and a corresponding exhaust valve, wherein a hydraulic compensator axis is angled with a corresponding valve axis of each of the plurality of intake valves and the plurality of exhaust valves.

26. An engine assembly of an off-road vehicle extending from a front end to a rear end in a longitudinal direction, the engine assembly comprising:
an engine comprising:
a cylinder head comprising at least one first opening on top of the cylinder head for receiving at least one spark plug;
a valve train assembly; and
a valve cover that is configured to be mounted on top of the cylinder head for housing the valve train assembly, wherein the valve cover is the same for a cylinder head with either forward intake ports and rearward exhaust ports or rearward intake ports and forward exhaust ports.

27. The engine assembly of claim 26, wherein the valve cover comprises at least one second opening for inserting at least spark plug therethrough into the at least one first opening of the cylinder head, thereby lower end of the at least one spark plug exposed within a top of each cylinder, wherein the at least one first opening aligns with the at least one second opening.

28. The engine assembly of claim 26, wherein the cylinder head comprises a recess surrounding a perimeter of the at least one first opening of the cylinder head, wherein a bottom of the recess is positioned at a seventh distance from a top edge of the recess.

29. The engine assembly of claim 28, wherein the valve cover comprises a first seal for providing sealing between the at least one first opening of the cylinder head and the at least one second opening of the valve cover.

30. The engine assembly of claim 29, wherein the first seal is configured to be positioned in the recess of the cylinder head.

31. The engine assembly of claim 30, wherein an underside of the valve cover comprises a flat surface surrounding a bottom of the at least one second opening for interfacing with a flat top surface of the first seal of the valve cover.

32. The engine assembly of claim 26, wherein the valve cover comprises a groove along a bottom edge of the valve cover surrounding a perimeter of the valve cover.

33. The engine assembly of claim 32, wherein the groove is configured to receive a second seal for providing sealing between the valve cover and the cylinder head.

34. The engine assembly of claim 26, wherein the valve cover comprises at least one convex portion at a bottom surface that is configured to align with at least one concave portion on top of the cylinder head.

35. An engine assembly of an off-road vehicle extending from a front end to a rear end in a longitudinal direction, the engine assembly comprising:
an engine comprising:
a cylinder head comprising at least one first opening on top of the cylinder head for receiving at least one spark plug and a recess surrounding a perimeter of the at least one first opening of the cylinder head; and
a valve cover that is configured to be mounted on top of the cylinder head for housing a valve train assembly.

36. The engine assembly of claim 35, wherein the recess configured to receive a first seal of the valve cover, wherein a flat surface of the valve cover interface with a flat top surface of the first seal.

37. An engine assembly for an off-road vehicle comprising:
a crankcase including a forward face, a rearward face, a first side extending from the forward face to the rearward face, and a second side extending from the forward face to the rearward face;
a crankshaft extending outward from the first side of the crankcase;
one of a first cylinder head and a second cylinder head, the one of the first cylinder head and the second cylinder head being connected to the crankcase, the first cylinder head including a forward face including an air intake port and a rearward face including an exhaust port, the second cylinder head including a forward face including an exhaust port and a rearward face including an air intake port;
a first camshaft and a second camshaft, wherein the spacing between the first camshaft and the second camshaft is the same regardless of which one of the first cylinder head and the second cylinder head is connected to the crankcase; and
a drivetrain chain operably connected to the crankshaft, the first camshaft, and the second camshaft, wherein a drivetrain chain is the same regardless of which one of the first cylinder head and the second cylinder head is connected to the crankcase.
